(19) United States
(12) Patent Application Publication
(10) Pub. No.: US 2016/0379388 A1
(43) Pub. Date: Dec. 29, 2016

(54) SYSTEM AND METHOD FOR COMBINING GEOGRAPHICAL AND ECONOMIC DATA EXTRACTED FROM SATELLITE IMAGERY FOR USE IN PREDICTIVE MODELING

(71) Applicant: DigitalGlobe, Inc., Longmont, CO (US)

(72) Inventors: Heath P. Rasco, Tampa, FL (US); Eugene Polishchuk, Kensington, MD (US); James Stokes, Richmond, VA (US)

(21) Appl. No.: 14/801,740

(22) Filed: Jul. 16, 2015

Related U.S. Application Data
(60) Provisional application No. 62/025,011, filed on Jul. 16, 2014.

(51) Int. Cl. G06T 11/20; G06F 3/0484; G06N 99/00; G06K 9/00; G06F 17/30; H04L 29/08; G06T 1/00

(52) U.S. Cl. CPC G06T 11/206; H04L 67/10; G06F 3/0484; G06T 1/0007; G06K 9/00651; G06F 17/30327; G06F 17/3028; G06N 99/005; G06T 2200/24; H04L 67/42

(57) ABSTRACT

A system and method for combining geographical and economic data extracted from satellite images, said information enriched with data pulled from additional sources, all aggregated as layers into a geo-spatial temporal map, wherein this current and historic information is used to generate predictions of future urban growth.

### CROSS-REFERENCE TO RELATED APPLICATIONS

The present application claims the benefit of, and priority to, U.S. provisional patent application Ser. No. 62/025,011, titled “SYSTEM AND METHOD FOR CREATING MAPS SHOWING ECONOMIC ACTIVITY, ETHNIC BACKGROUNDS AND LANGUAGES USED USING AUTOMATIC MAPPING OF GEO-LINKED DATA TO AUTO-CREATED MAPS FOR USE IN PREDICTIVE MODELING” and filed on Jul. 16, 2014, the entire specification of which is herein incorporated by reference in its entirety.

### BACKGROUND OF THE INVENTION

Field of the Invention

The present invention is in the field of image analysis, and more particularly in the field of platforms for automatically generating maps of human settlement and economic activity using large scale imagery and external data sources.

Discussion of the State of the Art

Information on human settlements is crucial for a wide range of applications including emergency response, disaster risk reduction, population estimation/analysis, and urban/regional planning. Urbanization pressure generates environmental impacts, indicates population growth, and relates to risk and disaster vulnerability. For instance, the global population passed the mark of 7.0 billion in 2011 with more than half of the population living in urban areas. Between 2011 and 2050, the urban population is expected to increase by about 2.7 billion, passing from 3.6 billion in 2011 to 6.3 billion in 2050. The population growth in urban areas is projected to be concentrated in the cities and towns of the less developed countries and continents. Asia, in particular, is projected to see its urban population increase by 1.4 billion, Africa by 0.9 billion, and Latin America and the Caribbean by 0.2 billion.

Population growth is therefore becoming largely an urban phenomenon concentrated in the developing world resulting in major challenges to manage the urban development in a sustainable manner. A central issue in this respect is the availability of up-to-date information on the extent and quality of the urban settlement (e.g., the urban “build-up” or “built-up”) which is largely unavailable in developing countries. For instance, cities are often growing at a pace that cannot be fully controlled by the local or regional mapping agencies. As demographic pressure increases exponentially at a global level, the ability to monitor, quantify and characterize urbanization processes around the world is becoming paramount. The information about the quality of urban development can provide precious input for understanding the vulnerability of the population living on our planet.

While satellite imagery could provide information about the world-wide built-up environment, there are few global data sets available that could be used to map the human settlements. Examples include the night-time lights of the world based on the Defense Meteorological Satellite Program-Operational Linescan System (DMSP-OLS) sensor, Moderate Resolution Imaging Spectroradiometer (MODIS) based land use/land cover classifications, and global population data sets like LANDSCAN™ or the gridded population of the world (GPW). While the aforementioned data sets are useful for global analysis, the data sets have the tendency to under-represent small, scattered rural settlements due to the low spatial resolution of the data sets between, for instance, 500 and 2,000 m. Furthermore, the data sets represent single snap-shots in time that do not allow for regular monitoring. Still further, if the data sets are updated (e.g., the LANDSCAN™ data set), they are not directly comparable due to changing input sources.

What is needed is a system and method for mapping, known as an anthropological mapping system (AMS) that enables users to generate human terrain maps based on elevation, population, and known tribal locations. Further needed are projection bases for future development of economic activity, population movements, crime trends, and other threats.

### SUMMARY OF THE INVENTION

Accordingly, the inventor has conceived and reduced to practice, in preferred embodiments of the invention, a system and method for combining geographic and economic data extracted from satellite imagery for use in predictive modeling.

In a preferred embodiment of the invention, a system for combining geographical and economic data extracted from satellite imagery, comprising an application server comprising at least a plurality of programming instructions stored in a memory and operating on a processor of a network-connected computing device and configured to receive input from a plurality of users via a network, at least one of the users comprising an administrative user, the input from an administrative user comprising at least a plurality of campaign configuration information, and configured to operate a crowdsourced campaign based at least in part on at least a portion of the campaign configuration information, the crowdsourced campaign comprising at least a plurality of image analysis tasks, and further configured to provide at least a portion of a plurality of image analysis tasks associated with a campaign to at least a portion of a plurality of users, and further configured to provide at least a portion of a plurality of image data to at least a portion of a plurality of users; and a crowdrank server comprising at least a plurality of programming instructions stored in a memory and operating on a processor of a computing device, and configured to receive a plurality of input from a plurality of users, the input comprising at least a plurality of information tags associated with at least a portion of a plurality of image data, and further configured to analyze at least a portion of the information tags and organize the portion of tags based at least in part on the analysis results, is disclosed.

In another preferred embodiment of the invention, a method for ranking a plurality of crowdsourced image analysis information, comprising the steps of sending, via an application server comprising at least a plurality of programming instructions stored in a memory and operating on a processor of a network-connected computing device and configured to receive input from a plurality of users via a network, at least one of the users comprising an administrative user, the input from an administrative user comprising at least a plurality of campaign configuration information, and configured to operate a crowdsourced campaign based at least in part on at least a portion of the campaign configuration information, the crowdsourced campaign comprising at least a plurality of image analysis tasks, and further configured to provide at least a portion of a plurality of image analysis tasks associated with a campaign to at least a portion of a plurality of users, and further configured to provide at least a portion of a plurality of image data to at least a portion of a plurality of users, a plurality of image information to a plurality of users; receiving, at a crowdrank server comprising at least a plurality of programming instructions stored in a memory and operating on a processor of a computing device, and configured to receive a plurality of input from a plurality of users, the input comprising at least a plurality of information tags associated with at least a portion of a plurality of image data, and further configured to analyze at least a portion of the information tags and organize the portion of tags based at least in part on the analysis results, a plurality of user input comprising at least a plurality of information tags associated with at least a portion of a plurality of image information; analyzing at least a portion of the information tags to determine at least an agreement value corresponding to at least a number of users that provided a similar information tag; and storing at least a portion of the information tags for future reference, is disclosed.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a simplified block diagram illustrating a process of extracting structures of interest from satellite imagery data.

FIG. 2 is a more detailed block diagram of an automated extraction system for obtaining structures of interest from satellite imagery data.

FIG. 3 is a block diagram of a Max-Tree for hierarchically arranging components of an input satellite image.

FIG. 4a is a schematic diagram of a KD-Tree based spaced partitioning procedure for use in hierarchically arranging feature elements of the components of FIG. 3.

FIG. 4b is a KD-Tree built from the partitioning procedure illustrated in FIG. 4a.

FIG. 5 is a flow diagram of a method for extracting structures of interest from satellite imagery data.

FIG. 6 illustrates overlapping portions of a National Land Cover Database 2006 information layer and a plurality of multispectral images acquired by the WorldView 2 satellite over a portion of Texas near Dallas, Tex.

FIG. 7a is a close-up of a resultant image including built-up extracted from the multispectral images of FIG. 6 using the information layer of FIG. 6, where the close-up is at a first level of zoom.

FIG. 7b is a close-up of the information layer of FIG. 6 corresponding to the resultant image close-up of FIG. 7a.

FIG. 8a is a resultant image close-up similar to the close-up of FIG. 7a, but at a closer, second level of zoom.

FIG. 8b is a close-up of the multispectral images of FIG. 6 corresponding to the resultant image close-up of FIG. 8a

FIG. 9 is a block diagram illustrating an exemplary hardware architecture of a computing device used in various embodiments of the invention.

FIG. 10 is a block diagram illustrating an exemplary logical architecture for a client device, according to various embodiments of the invention.

FIG. 11 is a block diagram illustrating an exemplary architectural arrangement of clients, servers, and external services, according to various embodiments of the invention.

FIG. 12 is a diagram of an exemplary architecture for a platform for crowdsourced image analysis, according to a preferred embodiment of the invention.

FIG. 13 is a process flow diagram of a method to allow a plurality of users to participate in crowdsourced image analysis, according to a preferred embodiment of the invention.

FIG. 14 is a process flow diagram of a method for estimating location and quality of a set of geolocation data based on tag data provided by a plurality of users of a crowdsourced image analysis platform of the invention.

FIG. 15 is a process flow diagram of a method to accurately geolocate a plurality of targets using a crowdsourced image analysis platform of the invention.

FIG. 16 is another block diagram illustrating an exemplary hardware architecture of a computing device used in various embodiments of the invention.

FIG. 17 is a high-level process flow diagram of a method to enhance map data derived from images using a crowdsourced image analysis platform of the invention

FIG. 18 is a data flow process diagram showing the more detailed use of a crowd members ranking system (CMRS) and a vector extraction and verification system (VEVS) in the overall system and method for crowdsourcing map data extraction and improvement from images.

FIG. 19 is a data flow process diagram showing the more detailed use of a signature analysis system (SAS) in a crowdsourced image analysis platform of the invention.

FIG. 20 is a data flow process diagram showing the use of crowdsource participants with high reliability scores to continue the process of data editing and corrections in selected prioritized regions.

FIG. 21 is a process diagram showing the use of crowdsource participants with high reliability scores to refine map data.

FIG. 22 is a workflow summary for assembling the data for an automated mapping system (AMS) mapping.

FIG. 23 is a continuation of the workflow summary of FIG. 22.

FIG. 24 a hydrological workflow for developing a watershed model.

FIG. 25 is a data flow process diagram for viewing the data previously assembled.

### DETAILED DESCRIPTION

Accordingly, the inventor has conceived and reduced to practice, in preferred embodiments of the invention, a system and method for combining geographic and economic data extracted from satellite imagery for use in predictive modeling.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### DEFINITIONS

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various embodiments may preferentially employ one or another of the various data storage subsystems available in the art (or available in the future), the invention should not be construed to be so limited, as any data storage architecture may be used according to the embodiments. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

Similarly, preferred embodiments of the invention are described in terms of a web-based implementation, including components such as web servers and web application servers. However, such components are merely exemplary of a means for providing services over a large-scale public data network such as the Internet, and other implementation choices may be made without departing from the scope of the invention. For instance, while embodiments described herein deliver their services using web services accessed via one or more webs servers that in turn interact with one or more applications hosted on application servers, other approaches such as peer-to-peer networking, direct client-server integration using the Internet as a communication means between clients and servers, or use of mobile applications interacting over a mobile data network with a one or more dedicated servers are all possible within the scope of the invention. Accordingly, all references to web services, web servers, application servers, and an Internet should be taken as exemplary rather than limiting, as the inventive concept is not tied to these particular implementation choices.

As used herein, “crowdsourced” refers to the use of large numbers of participants, each working independently of the others over the Internet, to accomplish a complex or large (or both) task provided by a requesting entity. Generally, the task is divided into many subtasks, each of which can be completed satisfactorily by a human without reference to any other information beyond what is provided with the subtask. These subtasks are distributed by a “crowdsourcing platform” to many different participants, some of whom receive more or less subtask volume based on quality, cost, willingness, or other parameters. In some cases, participants “pull” subtasks from an inventory of pending subtasks. Furthermore, in some embodiments subtasks may be generated “on the fly” by users, for example by a user's spontaneously requesting that an object be identified. Some subtasks may be submitted to more than one participant, while others may be provided only to one participant. As each participant completes the subtasks assigned (or pulled), the resulting work is aggregated by the platform and a completed set of results for the overall task is provided to the original requesting entity.

As used herein, “crowdsourcing campaign” refers to a specific instance of a crowdsourcing application used to solve a specific problem. For instance, a crowdsourced image analysis platform of the invention facilitates image analysis by many users; a crowdsourcing campaign organizes such activities (and such users) for a specific image analysis problem. For example, a crowdsourcing campaign might be set up and operated whose goal is to find a downed airplane. Generally the crowdsourcing platform will be configured generally for a plurality of campaigns, but a specific campaign will have its own configuration; in the example given, the campaign's configuration would include the expected region of interest and imagery associated with it, particular details about how to distribute image analysis tasks in the campaign, what criteria will be used to identify to a requesting entity when a target of interest is identified and what confidence level exists for the identification, and so forth.

As used herein, “search and locate” refers to a general class of problems wherein a set of images is searched for particular classes of targets (such as buildings, tanks, railroad terminals, downed airplanes, etc.). It is common that the set of images may be searched to find more than one class of targets (for example, to find all targets of military interest), although single target class searches may also be performed (“find all cars”). Moreover, in some cases it may be known or presumed) in advance that only a single target of interest exists (a lost climbing party, or a downed airplane), while in most cases the number of targets present in a given image set is unknown. The second part of the search and locate problem is to precisely locate any resulting targets of interest (where is the down plane or lost party of climbers?).

As used herein, “image analysis” refers to the analysis of images obtained from one or more image sensors; generally, a single analysis task focuses on a set of images of a single region of interest on the earth. Satellite and aerial imagery are common examples of imagery that are subjected to large scale image analysis. However, the invention described herein is not limited to common remote sensing image analysis problems associated with satellite and aerial imagery. For example, analysis of large image sets from traffic cameras may be performed using techniques described herein.

As used herein, a “requesting entity” is a person or organization that requests a specific set of crowdsourced image analysis campaigns to be carried out via a crowdsourcing platform. That is, a crowdsourcing platform may be operated by a single organization specialized in hosting such a platform, and be made available to a wide range of requesting entities (i.e., third parties) who may sign up for, manage, and pay the platform operator to execute various crowdsourcing campaigns. For example, a government agency seeking to augment a search and rescue operation may be a requesting entity, setting up an image analysis campaign on a crowdsourcing platform.

As used herein, a “participating user” is a person, or a group of persons, that participates in a crowdsourcing campaign as a provider of service. Crowdsourcing relies on distributing tasks to a crowd; that crowd is comprised of participating users.

As used herein, “tags” are data points created by a participating user's “tagging” a specific point as corresponding to a specific target type. For instance, a participating user may place his cursor over a location on an image that was presented to him, and select “tank” in order to generate a tag that states that a tank is present in that image at that location. In some embodiments, users may “tag” objects or regions by, for example, drawing polygons or other shapes surrounding them, using one or more drawing tools provided by a user interface according to the invention.

Although high resolution (HR, 1-10 m spatial resolution) and even very high resolution (VHR, <1 m) data with an almost global coverage is or will be available with different sensors (e.g., System for Earth Observation (SPOT), China-Brazil Earth Resources Satellite program (CBERS), RapidEye, IKONOS® 2, QuickBird, WorldView-1, WorldView-2, WorldView-3), no consistent global coverage of built-up settlements derived from these datasets exists. Mapping and monitoring of urban areas at HR and VHR scales is mostly limited in terms of temporal and spatial coverage. The lack of a consistent global layer with HR/VHR spatial resolution can be attributed to a number of reasons. In one regard, global coverage is costly due to, for instance, the fact that most HR/VHR satellite missions are operated on a commercial basis. In another regard, no systems have yet been able to demonstrate the capacity to automatically extract global information layers about human settlement (built-up structures such as cities, refugee camps, etc.) from HR/VHR satellite data with relatively low levels of time, effort (e.g., low number of processor clock cycles), and other computational costs.

It has thus been determined that globally and regionally consistent information from HR and VHR input image data (e.g., multispectral, panchromatic, etc.) is needed that can be obtained inside time constraints and data constraints (e.g., in relation to resolution, volume, quality, etc.) typical of crisis management scenarios. Broadly, disclosed herein are utilities (e.g., systems, processes, etc.) for automatically extracting or isolating structures or areas of interest (e.g., built-up structures such as buildings, houses, shelters, tents, etc.) from HR/VHR satellite imagery data using corresponding LR satellite imagery data. More particularly, the disclosed utilities employ a first hierarchical data structure (e.g., a “Max-Tree”) for organizing HR/VHR input images (e.g., of a particular geographic area) into a plurality of meaningful, hierarchically arranged, connected components in addition to determining one or more features or feature elements of each of the components (e.g., contrast, area, compactness, linearity, average spectral response, eccentricity or inertia of the component). The disclosed utilities also employ use of a second hierarchical data structure (e.g., a “KD-Tree”) for managing organization of the plurality of feature elements (i.e., of the “feature-space” of the input image). Generally, the second hierarchical data structure offers a structured representation of the feature-space from which a classification (e.g. built-up or non-built-up) of the components of the first hierarchical data structure can be directly determined. For instance, those components classified as built-up may be projected or otherwise mapped into a spatial domain of a resultant image having a high resolution (e.g., HR, VHR) with relatively low levels of computational effort.

As opposed to the classical paradigm of interactive learning followed by a time consuming model application on the spatial domain, the disclosed utilities shift the operational complexity to the feature space structuring. As a result, interactive classification of massive image data can be launched in near real-time. For instance, an experiment utilizing the disclosed utilities on an eightband multi-spectral image (each band obtaining an image that is 10070×58734 pixels) may be concluded in 577 seconds using a 2.4 GHz Intel® Core™ CPU and 8 GB RAM (thus representing 14,400 km/h/CPU). An interactive query of the information content may then be conducted on the classification results. When the hierarchical image and feature space data representation structures (i.e., the first and second hierarchical data structures) are stored in memory (e.g., volatile memory, such as RAM), scene classification (subject to different criteria) can be re-iterated rapidly to offer dynamic views of what may be massive image information content.

In one aspect, a method of extracting built-up structures (e.g., and/or other structures of interest) from satellite imagery data includes decomposing, using a processor, at least one input satellite image into a plurality of components (e.g., pixels or groups of pixels) of a first hierarchical data structure (e.g., a space-partitioning data structure for organizing data points, such as a MaxTree). The input image is associated with a geographic area (e.g., town, city, region, etc.) and has a first resolution (e.g., HR, such as 1-10 m spatial resolution; VHR, such as less than 1 m spatial resolution; etc.). Each of the components is characterized by at least one feature element (e.g., a k-dimensional shape and/or spectral descriptor such as contrast, area, compactness, linearity, average spectral response, standard deviation of spectral response, eccentricity or inertia of the component).

This method also includes constructing, using the processor, a second hierarchical data structure (e.g., another space-partitioning data structure for organizing data points, such as a KD-Tree) that includes a plurality of hierarchically-arranged nodes, where each of the feature elements depends from at least one of the nodes; and deriving or otherwise obtaining training components (e.g., training examples, such as 1000 components, 2000 components, etc.) from the plurality of components of the first hierarchical data structure that indicate built-up (e.g., and/or other structures of interest) and non-built-up structures (e.g., or other areas/land not of interest) in the input image using a first reference image data set (e.g., LANDSCAN™ population density reference layer, MODIS500 m Global Urban Extent (GUE) information layer, National Land Cover Database (NLCD) 2006, Corine Land Cover 2006, etc.) that is associated with the geographic area and has a second resolution lower than the first resolution. The first reference image data set may be one or more relatively low-resolution satellite imagery data sets (e.g., maps, layers) of any appropriate resolution (e.g., greater than 10 m spatial resolution, such as greater than 30 m spatial resolution, or even greater than 100 m spatial resolution) for which relatively consistent global coverage is available. For instance, one of the training components may identify a built-up structure or area when the training component falls within a built-up area as indicated by the first reference data set (e.g., when the training component includes pixels that fall within an area of increased population and/or built-up structures in the first reference data set).

In one arrangement, the method may include training, with the processor, the second hierarchical data structure with the feature elements of the training components for detecting built up structures. As an example, various feature elements in the second hierarchical data structure that are similar and/or substantially the same as feature elements of the training components may be identified. Thereafter, the various nodes of the second hierarchical data structure that are disposed on the same leaf-path (e.g., branch(es)) as the identified feature elements may be appropriately labeled (e.g., flagged, marked, etc.) as being in the same class (e.g., built-up or non-built-up) as the corresponding feature elements of the training components. For instance, each node of the second hierarchical data structure may include a “positive” (e.g., identifying built-up or other structure(s) of interest) class counter and/or a “negative” (e.g., identifying non-built-up or structure(s) not of interest) class counter. In this regard, the positive and/or negative counters of each node may be appropriately updated (e.g., incremented upwardly or downwardly) during the training process. In the event that subsets of feature elements in the second hierarchical data structure are clustered or grouped (e.g., are close enough with respect to some dissimilarity), any updates to class counters of the nodes along the same leaf-path as one of the feature elements may, in one embodiment, be automatically propagated to the class counters of the nodes along the same leaf-paths as one or more of the other feature elements in the clusters.

Thereafter, the method may include classifying, with the processor and using the trained second hierarchical data structure, the plurality of components of the first hierarchical data structure as identifying built-up structures or non-built-up structures. Stated differently, the method may include extracting, by the processor, those components in the first hierarchical data structure that depict built-up structures as identified by the trained second hierarchical data structure. As an example, the processor may systematically analyze and/or compare the collective set of feature elements for each component of the first hierarchical data structure in relation to the feature elements of the trained second hierarchical data structure to determine whether the component identifies a built-up structure or a non-built-up structure. For instance, a component (e.g., pixel or group of pixels) in the first hierarchical data structure may be labeled, tagged or classified as “built-up” when one or more (e.g., a majority, most, all, etc.) of its feature elements match or are similar to feature elements of the trained second hierarchical data structure associated with built-up structures (e.g., have a value within some percentage of the value of a feature element from the trained second hierarchical data structure).

In one arrangement, the method may include mapping or projecting components of the plurality of components that identify built-up structures as classified during the classifying step into a resultant image that is associated with the geographic area and that has a third resolution greater than the second resolution. For instance, the resultant image may be presented on any appropriate display (e.g., of a laptop, tablet, smartphone, etc.) and may be similar or even substantially the same as (e.g., in relation to spatial resolution, depicted geographic area, etc.) the input image but free of non-built-up structures (e.g., or free of areas that are not of interest). Advantageously, crisis management teams may be able to quickly and accurately assess possible high population areas to determine appropriate response strategies.

Various measures may be taken to improve the accuracy of the aforementioned built-up detection and extraction process. In one arrangement, the method may continue to perform the deriving, training and classifying steps with respect to additional portions of the plurality of components to further refine the accuracy of the detected and extracted built-up structures that are mapped into the resultant image. For instance, the method may include deriving additional training components (e.g., at least partially or fully non-overlapping with the previous set of training components, such as from a different portion of the input satellite image(s)) from the plurality of components of the first hierarchical data structure that indicate built-up and non-built-up structures in the input image using the first reference image data set; training, with the processor, the second hierarchical data structure with the feature elements of the additional training components for detecting built-up structures; and classifying, with the processor and using the second hierarchical data structure as trained with the additional training components, the plurality of components of the first hierarchical data structure as identifying built-up structures or not identifying built-up structures.

In another arrangement, the method may include ascertaining error rates (e.g., equal error rates (EER), etc.) between components that identify built-up structures from the classifying step and corresponding portions of a second reference data set (e.g., a low spatial resolution data set the same as or different than the first reference image data set, and that is assumed to have consistent, non-obscured global coverage) that identify built-up structures; and mapping components that identify built-up structures that are associated with error rates below a threshold error rate into a resultant image that is associated with the geographic areas and that has a third resolution that is greater than the second resolution. In one variation, built-up structure components may be extracted from successive input images of the geographic area (e.g., obtained via heterogeneous sources, different satellites, different locations, different times such as multitemporal images, different frequencies or wavelengths such as multispectral images, etc.) and mapped into the resultant image to allow for an iterative refinement of the resultant image over a plurality of cycles.

For instance, particular components of a first input image that have been classified as identifying built-up structures may be associated with error rates over a particular threshold when compared against corresponding portions of the second reference image data set (e.g., such as due to cloud cover or the like when the first input image was obtained). In this regard, the particular components of the first input image may be not mapped into the resultant image or at least mapped into the resultant image to a lesser degree (e.g., assigned a lower weight based how far over the threshold were the corresponding error rates). However, particular components of a second input image that have been classified as identifying built-up structures and over the same geographic vicinity as the particular components of the first input image may be associated with error rates below a particular threshold when compared against corresponding portions of the second reference image data set (e.g., such as due to the image being obtained from a high azimuth and during a partially or fully cloudless, sunny day).

In this regard, the particular components of the second input image may be mapped into the resultant image or even mapped into the resultant image to a greater degree (e.g., assigned a higher weight based how far under the threshold were the corresponding error rates). Advantageously, those built-up structure components that have been obscured for one reason or another from each successive input image (e.g., as determined by the ascertained error rates) may be at least partially excluded from the resultant image to allow the method to converge on extensive, high resolution coverage of built-up structures in the geographic area (e.g., where the resultant image includes at least some components of each of the successive input images). Stated differently, only those pixels of each of the successive images that are determined to be the “best” (e.g., as determined by the ascertained error rates) may be included in the resultant image.

In another aspect disclosed herein, a system for extracting structures of interest from optical images includes a construction engine, executable by a processor, that decomposes an input image associated with a geographic area and having a first resolution into a plurality of components, generates a first hierarchical data structure from the plurality of components that includes a plurality of k-dimensional feature elements of each of the components, and constructs a second hierarchical data structure that include a plurality of hierarchically-arranged nodes, where each of the plurality of k-dimensional feature elements depends from at least one of the nodes. The disclosed system also includes a training engine that uses feature elements of a first portion of the plurality of components of the first hierarchical data structure to t rain the second hierarchical data structure to detect components of the plurality of components in the first hierarchical data structure that correspond to structures of interest in the input image.

In one arrangement, the system includes a classification engine, executable by the processor, that uses the trained second hierarchical data structure to extract a second portion of the plurality of components of the first hierarchical data structure that corresponds to the structures of interest in the input image. For instance, the system may also include a mapping engine that maps the second portion into a resultant image that is associated with the geographic area and that has a third resolution that is greater than the second resolution.

Any of the embodiments, arrangements, or the like discussed herein may be used (either alone or in combination with other embodiments, arrangement, or the like) with any of the disclosed aspects. Merely introducing a feature in accordance with commonly accepted antecedent basis practice does not limit the corresponding feature to the singular. Any failure to use phrases such as “at least one” does not limit the corresponding feature to the singular. Use of the phrase “at least generally,” “at least partially,” “substantially” or the like in relation to a particular feature encompasses the corresponding characteristic and insubstantial variations thereof. Furthermore, a reference of a feature in conjunction with the phrase “in one embodiment” does not limit the use of the feature to a single embodiment.

In addition to the exemplary aspects and embodiments described above, further aspects and embodiments will become apparent by reference to the drawings and by study of the following descriptions.

The inventor has developed a platform for crowdsourcing the analysis of images, and particularly for analysis of aerial or satellite images to geolocate one or more targets of interest, or to identify objects or their types.

According to a preferred embodiment of the invention, a crowdsourced search and locate platform, comprising an application server and a server for a crowd members ranking system (CMRS) such as, for example, the CROWDRANK™ system. The application server: receives connections from crowdsourcing participants; navigates a first crowdsourcing participant to a specific geospatial location; sends an image corresponding to the geospatial location to the first crowdsourcing participant; receives tagging data from the first crowdsourcing participant, the tagging data corresponding to a plurality of objects and locations identified by the first crowdsourcing participant. The CROWDRANK™ server: retrieves a plurality of tags made by participating users computes agreement and disagreement values for each of the plurality of retrieved tags; performs an expectation-maximization or expectation-minimization process iteratively until a configured maximum number of iterations is performed or until an indicia of rate of change between iterations falls below a configured threshold; and provides resulting output values corresponding to geolocations of objects of a plurality of types to an administrative user.

According to another preferred embodiment of the invention, a method for conducting crowdsourced search and locate operations, the method comprising the steps of: (a) receiving connections to an application server coupled to a digital packet network from a plurality of crowdsourcing participants; (b) navigating a first crowdsourcing participant to a specific geospatial location; (c) sending an image corresponding to the geospatial location to the first crowdsourcing participant; (d) receiving tagging data from the first crowdsourcing participant, the tagging data corresponding to a plurality of objects and locations identified by the first crowdsourcing participant; (e) retrieving, at a crowd rank server stored and operating on a network-attached computer, a plurality of tags made by participating users by repeated carrying out of steps (a) through (d); (f) computing agreement and disagreement values for each of the plurality of retrieved tags; (g) performing an expectation-maximization or expectation-minimization process iteratively until a configured maximum number of iterations is performed or until an indicia of rate of change between iterations falls below a configured threshold; and (h) providing resulting output values corresponding to geolocations of objects of a plurality of types to an administrative user.

The basic problem in an AMS is the integration of several elements, such as urban mapping, human and social geo-spatial information, and information from other additional sources, to enable and extend the functionality and availability of these information pieces in one comprehensive tool. Specifically, integrating an automatically generated human urban geography (HUG) data set generated in near-real-time from satellite imagery expands the utility of an AMS and its related data significantly. Using automated HUG data, geo-spatially tied data regarding building locations and sizes can be added. Further, automated road network generation can create a road network even in areas where accurate maps aren't available. Also, accurate digital elevation models (generated automatically from satellite imagery) and use of friction surfaces can be incorporated to enable exemplary predictions of future urban growth, particularly when coupled to an up-to-date data set of roads (including unofficial roads and paths). Even retail traffic can be determined automatically using parking lot detection and usage measurement. And automated counting, from satellite imagery, of things such as rail car inventories, oil tank farm inventories, farm animal head counts, and the like provides additional geo-spatially referenced economic data. Such an AMS ingests all these data sources and automatically analyzes them to produce human geography data sets and predictions about the future (for example, which tribes are dominant in which areas, what languages are spoken where, where is radicalization most likely to occur, where are future likely high-crime areas based on predicted population and infrastructure growth). And, given the near-real-time aspect that can achieved, mobile use cases such as providing assets in the field with a real-time heads up about emerging threats determined from human geography (for example, recent trends indicating development of a hostile crowd in the vicinity of a mobile asset, with threat delivered to mobile device in real time).

Further, an area of interest (AOI) could be mapped out. For purposes of a practical example, the state of Colorado is considered herein; however the system and method disclosed herein can apply to any location worldwide. For example, in Colorado, many different populations co-exist. Some have Native American tribal roots. Others are very recent immigrants, often from Latin America. In some AOIs, there may be delineation by geographical features (valleys, ridges, etc.). Most of geo-spatial anthropoid segregation is due to historic phases of humans arriving in the area and staying together as a group. Early groups followed watersheds and looked for low passes to connect to other watersheds. Existing maps can be added to enhance features. In the case of Colorado, maps could be created from a USGS survey, open source maps, etc., or whatever other sources are available for an AOI. Terrain information and population information can be added, either from a HUG-type system, or other public domain sources. In some cases, additional information may be licensed from private information owners, etc. The terrain and population information is used to assign areas on the ground where people are; then additional information is added to those geographic locations. This combined information then becomes a valuable asset that can generate revenue and competitive differentiation.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

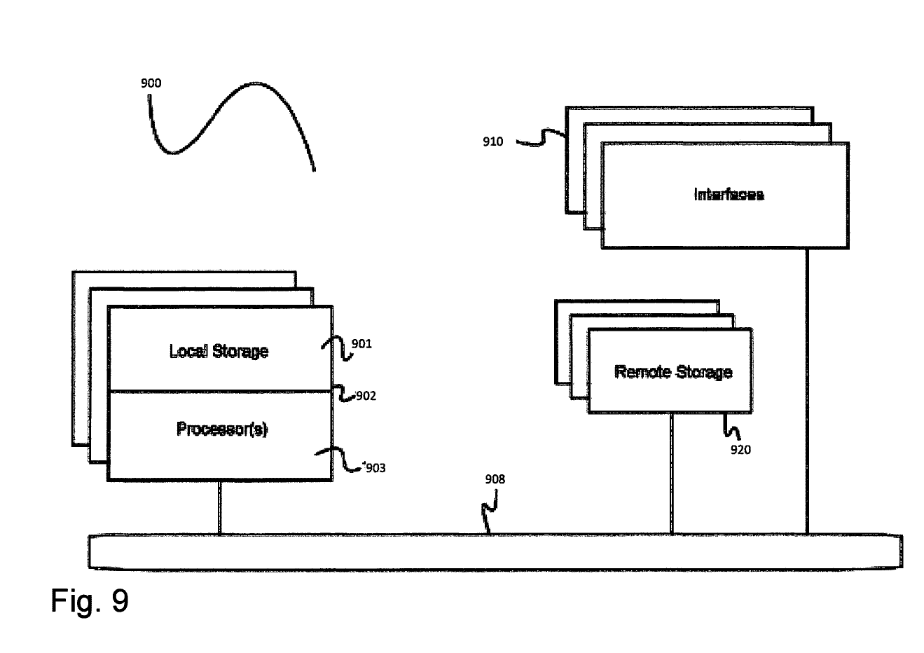

Referring now to FIG. 9, there is shown a block diagram depicting an exemplary computing device 900 suitable for implementing at least a portion of the features or functionalities disclosed herein. Computing device 900 may be, for example, any one of the computing machines listed in the previous paragraph, or indeed any other electronic device capable of executing software- or hardware-based instructions according to one or more programs stored in memory. Computing device 900 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 900 includes one or more central processing units (CPU) 902, one or more interfaces 910, and one or more busses 906 (such as a peripheral component interconnect (PCI) bus). When acting under the control of appropriate software or firmware, CPU 902 may be responsible for implementing specific functions associated with the functions of a specifically configured computing device or machine. For example, in at least one embodiment, a computing device 900 may be configured or designed to function as a server system utilizing CPU 902, local memory 901 and/or remote memory 920, and interface(s) 910. In at least one embodiment, CPU 902 may be caused to perform one or more of the different types of functions and/or operations under the control of software modules or components, which for example, may include an operating system and any appropriate applications software, drivers, and the like.

CPU 902 may include one or more processors 903 such as, for example, a processor from one of the Intel, ARM, Qualcomm, and AMD families of microprocessors. In some embodiments, processors 903 may include specially designed hardware such as application-specific integrated circuits (ASICs), electrically erasable programmable read-only memories (EEPROMs), field-programmable gate arrays (FPGAs), and so forth, for controlling operations of computing device 900. In a specific embodiment, a local memory 901 (such as non-volatile random access memory (RAM) and/or read-only memory (ROM), including for example one or more levels of cached memory) may also form part of CPU 902. However, there are many different ways in which memory may be coupled to system 900. Memory 901 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 910 are provided as network interface cards (NICs). Generally, NICs control the sending and receiving of data packets over a computer network; other types of interfaces 910 may for example support other peripherals used with computing device 900. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire, PCI, parallel, radio frequency (RF), Bluetooth, near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 910 may include ports appropriate for communication with appropriate media. In some cases, they may also include an independent processor and, in some instances, volatile and/or non-volatile memory (e.g., RAM).

Although the system shown in FIG. 9 illustrates one specific architecture for a computing device 900 for implementing one or more of the inventions described herein, it is by no means the only device architecture on which at least a portion of the features and techniques described herein may be implemented. For example, architectures having one or any number of processors 903 may be used, and such processors 903 may be present in a single device or distributed among any number of devices. In one embodiment, a single processor 903 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 920 and local memory 901) configured to store data, program instructions for the general-purpose network operations, or other information relating to the functionality of the embodiments described herein (or any combinations of the above). Program instructions may control execution of or comprise an operating system and/or one or more applications, for example. Memory 920 or memories 901, 920 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java compiler and may be executed using a Java virtual machine or equivalent, or files containing higher level code that may be executed by the computer using an interpreter (for example, scripts written in Python, Perl, Ruby, Groovy, or any other scripting language).

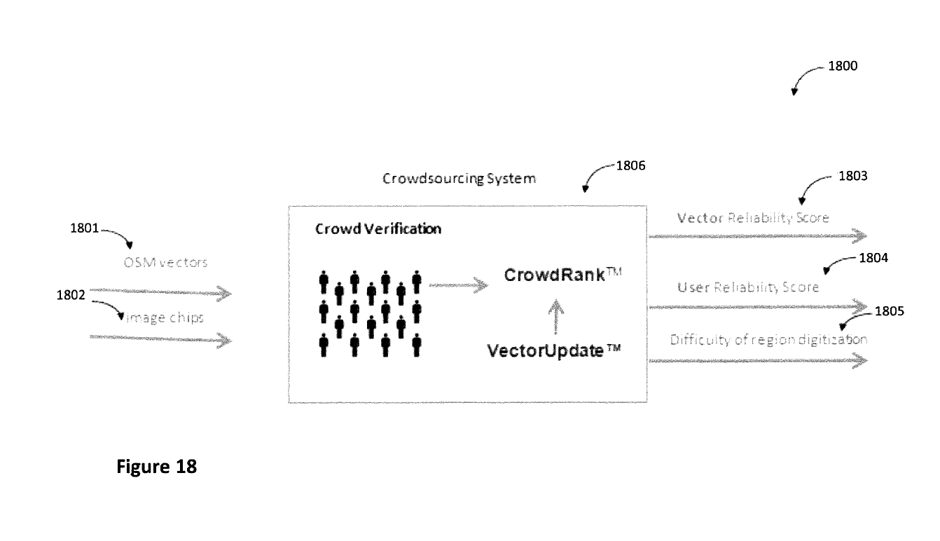

In some embodiments, systems according to the present invention may be implemented on a standalone computing system. Referring now to FIG. 18, there is shown a block diagram depicting a typical exemplary architecture of one or more embodiments or components thereof on a standalone computing system. Computing device 1800 includes processors 1010 that may run software that carry out one or more functions or applications of embodiments of the invention, such as for example a client application 1030. Processors 1010 may carry out computing instructions under control of an operating system 1020 such as, for example, a version of Microsoft's Windows operating system, Apple's Mac OS/X or iOS operating systems, some variety of the Linux operating system, Google's Android operating system, or the like. In many cases, one or more shared services 1025 may be operable in system 1000, and may be useful for providing common services to client applications 1030. Services 1025 may for example be Windows services, user-space common services in a Linux environment, or any other type of common service architecture used with operating system 1010. Input devices 1070 may be of any type suitable for receiving user input, including for example a keyboard, touchscreen, microphone (for example, for voice input), mouse, touchpad, trackball, or any combination thereof. Output devices 1060 may be of any type suitable for providing output to one or more users, whether remote or local to system 1000, and may include for example one or more screens for visual output, speakers, printers, or any combination thereof. Memory 1040 may be random-access memory having any structure and architecture known in the art, for use by processors 1010, for example to run software. Storage devices 1050 may be any magnetic, optical, mechanical, memristor, or electrical storage device for storage of data in digital form. Examples of storage devices 1050 include flash memory, magnetic hard drive, CD-ROM, and/or the like.

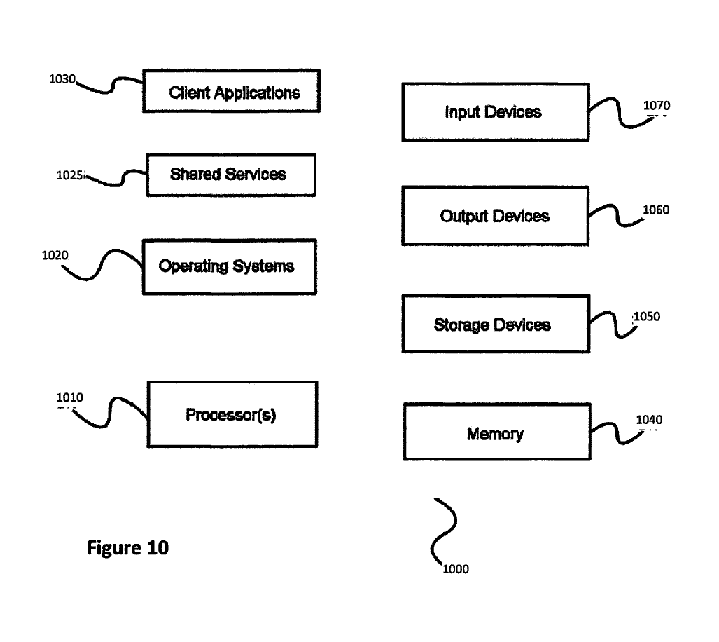

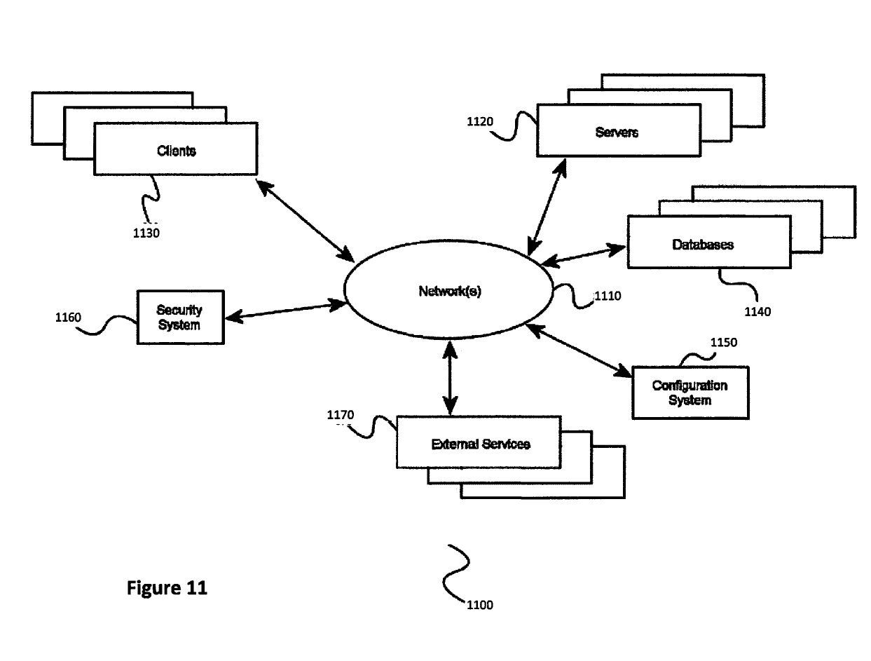

In some embodiments, systems of the present invention may be implemented on a distributed computing network, such as one having any number of clients and/or servers. Referring now to FIG. 11, there is shown a block diagram depicting an exemplary architecture for implementing at least a portion of a system according to an embodiment of the invention on a distributed computing network. According to the embodiment, any number of clients 1130 may be provided. Each client 1130 may run software for implementing client-side portions of the present invention; clients may comprise a system 1000 such as that illustrated in FIG. 10. In addition, any number of servers 1120 may be provided for handling requests received from one or more clients 1130. Clients 1130 and servers 1120 may communicate with one another via one or more electronic networks 1110, which may be in various embodiments of the Internet, a wide area network, a mobile telephony network, a wireless network (such as WiFi, Wimax, and so forth), or a local area network (or indeed any network topology known in the art; the invention does not prefer any one network topology over any other). Networks 1110 may be implemented using any known network protocols, including for example wired and/or wireless protocols.

In addition, in some embodiments, servers 1120 may call external services 1170 when needed to obtain additional information, or to refer to additional data concerning a particular call. Communications with external services 1170 may take place, for example, via one or more networks 1110. In various embodiments, external services 1170 may comprise web-enabled services or functionality related to or installed on the hardware device itself. For example, in an embodiment where client applications 1030 are implemented on a smartphone or other electronic device, client applications 1030 may obtain information stored in a server system 1120 in the cloud or on an external service 1170 deployed on one or more of a particular enterprise's or user's premises.

In some embodiments of the invention, clients 1130 or servers 1120 (or both) may make use of one or more specialized services or appliances that may be deployed locally or remotely across one or more networks 1110. For example, one or more databases 1140 may be used or referred to by one or more embodiments of the invention. It should be understood by one having ordinary skill in the art that databases 1140 may be arranged in a wide variety of architectures and using a wide variety of data access and manipulation means. For example, in various embodiments one or more databases 1140 may comprise a relational database system using a structured query language (SQL), while others may comprise an alternative data storage technology such as those referred to in the art as “NoSQL” (for example, Hadoop, MapReduce, BigTable, and so forth). In some embodiments variant database architectures such as column-oriented databases, in-memory databases, clustered databases, distributed databases, key-value stores, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 1160 and configuration systems 1150. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 1160 or configuration 1150 system or approach is specifically required by the description of any specific embodiment.

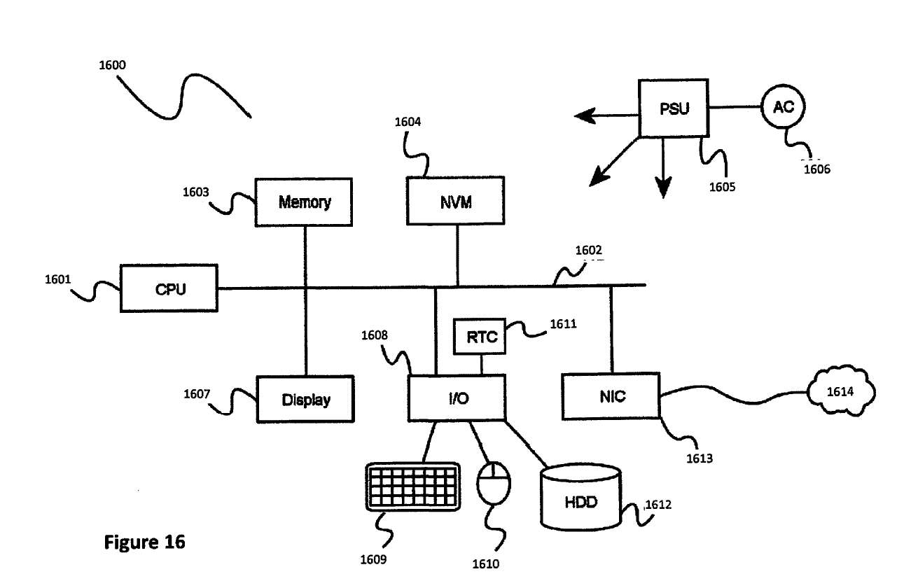

FIG. 16 shows an exemplary overview of a computer system 1600 as may be used in any of the various locations throughout the system. It is exemplary of any computer that may execute code to process data. Various modifications and changes may be made to computer system 1600 without departing from the broader scope of the system and method disclosed herein. CPU 1601 is connected to bus 1602, to which bus is also connected memory 1603, nonvolatile memory 1604, display 1607, I/O unit 1608, and network interface card (NIC) 1613. I/O unit 1608 may, typically, be connected to keyboard 1609, pointing device 1610, hard disk 1612, and real-time clock 1611. NIC 1613 connects to network 1614, which may be the Internet or a local network, which local network may or may not have connections to the Internet. Also shown as part of system 1600 is power supply unit 1605 connected, in this example, to ac supply 1606. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices)

In various embodiments, functionality for implementing systems or methods of the present invention may be distributed among any number of client and/or server components. For example, various software modules may be implemented for performing various functions in connection with the present invention, and such modules can be variously implemented to run on server and/or client components.

A computer program (also known as a program, software, software application, script, or code) used to provide any of the functionalities described herein (e.g., construction of the first and second hierarchical data structures and the like) can be written in any appropriate form of programming language including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program may include, by way of example, both general and special purpose microprocessors, and any one or more processors of any kind of digital computer. Generally, a processor will receive instructions and data from a read-only memory or a random access memory or both. Generally, the elements of a computer are one or more processors for performing instructions and one or more memory devices for storing instructions and data. The techniques described herein may be implemented by a computer system configured to provide the functionality described.

While this specification contains many specifics, these should not be construed as limitations on the scope of the disclosure or of what may be claimed, but rather as descriptions of features specific to particular embodiments of the disclosure. Furthermore, certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

### DETAILED DESCRIPTIONS OF EMBODIMENTS

FIG. 16 shows an exemplary overview of a computer system 1600 as may be used in any of the various locations throughout the system. It is exemplary of any computer that may execute code to process data. Various modifications and changes may be made to computer system 1600 without departing from the broader spirit and scope of the system and method disclosed herein. CPU 1601 is connected to bus 1602, to which bus is also connected memory 1603, nonvolatile memory 1604, display 1607, I/O unit 1608, and network interface card (NIC) 1613. I/O unit 1608 may, typically, be connected to keyboard 1609, pointing device 1610, hard disk 1612, and real-time clock 1611. NIC 1613 connects to network 1614, which may be the Internet or a local network, which local network may or may not have connections to the Internet. Also shown as part of system 1600 is power supply unit 1605 connected, in this example, to ac supply 1606. Not shown are batteries that could be present, and many other devices and modifications that are well known but are not applicable to the specific novel functions of the current system and method disclosed herein.

Disclosed herein are utilities (e.g., systems, processes, etc.) for automatically extracting or isolating structures or areas of interest (e.g., built-up structures such as buildings, houses, shelters, tents; agricultural areas; etc.) from HR/VHR satellite imagery data using corresponding LR satellite imagery data. The disclosed utilities employ a unique use of first and second hierarchical data structures (e.g., space-partitioning data structures for organizing data points, such as Max and KD-Trees) to break down HR and/or VHR input satellite images into a plurality of hierarchically arranged connected portions or components (e.g., groups of pixels), organize corresponding feature elements (e.g., spectral and shape characteristics) of each of the components into a manageable structure, train the manageable structure of feature elements to recognize structures of interest in the components, classify the various components of the input image with the trained feature elements, extract components classified as structures of interest from the input image, and map the extracted components into a resultant image that includes the various structures of interest. The disclosed utilities can be executed at high rates of speed and with reduced use of computational resources. The resultant images can be used in numerous contexts such as in assessing population densities, qualities of life, vulnerability factors, disaster risks, sufficiency of civil infrastructures, economic growth, poverty levels, event monitoring and evolution, and the like.

At the outset, it is noted that, when referring to the earth herein, reference is made to any celestial body of which it may be desirable to acquire images or other remote sensing information. Furthermore, when referring to a satellite herein, reference is made to any spacecraft, satellite, and/or aircraft capable of acquiring images or other remote sensing information. Furthermore, the utilities described herein may also be applied to other imaging systems, including imaging systems located on the earth or in space that acquire images of other celestial bodies. It is also noted that the drawing figures contained herein are not necessarily drawn to scale and that such figures have been provided for the purposes of discussion and illustration only.

Generally, high resolution images of selected portions of a celestial body's surface have become a product desired and used by government agencies, corporations, and individuals. For instance, many consumer products in common use today include images of the Earth's surface, such as Google® Earth. Various types of remote sensing image collection platforms may be employed, including aircraft, earth-orbiting satellites, and the like. In the case of a consumer digital camera, as one non-limiting example, an image sensor is generally arranged in an area array (e.g., 3,000 rows of 3,000 pixels each, or 9,000,000 total pixels) which collects the image area in a single “snapshot.” In the case of satellite-based imaging, as another non-limiting example, the “push-broom scanning” principle is sometimes employed whereby each image sensor includes a relatively small number of rows of a great number of pixels (e.g., 50,000 or more) in each row. Each row of pixels may be scanned across the earth to build an image line by line, and the width of the image is the product of the number of pixels in the row times the pixel size or resolution (e.g., 50,000 pixels at 0.5 meter ground resolution produces an image that is 25,000 meters wide). The length of the image is controlled by the scan duration (i.e. number of lines), which is typically settable for each image collected. The resolution of satellite images varies depending on factors such as the particular instrumentation utilized, the altitude of the satellite's orbit, and the like.

Image collection platforms (e.g., aircraft, earth-orbiting satellites, etc.) may collect or acquire various types of imagery in one or more manners. As one non-limiting example, image collection platforms may perform panchromatic collection of scenes of a celestial body which generally refers to the collection of image data across a single broad range of wavelengths (e.g., all visible light, from near infrared (NIR) to near ultraviolet (NUV), etc.). As another non-limiting example, image collection platforms may additionally or alternatively capture image data within the visible light band and include respective filters to separate the incoming light into red, green and blue portions. As a further non-limiting example, image collections platforms may additionally or alternatively perform multispectral collection of scenes of a celestial body which generally refers to the collection of image data at multiple specific spectral bands across the electromagnetic spectrum (e.g., within bands both inside and outside of the visible light range such as NIR, short wave infrared (SWIR), far infrared (FIR), etc.). For instance, a satellite may have one image sensor that is sensitive to electromagnetic radiation across only a first spectral band (e.g., the visible light band, such as a wavelength range of about 380-750 nm) in addition to one or more additional image sensors that are sensitive to electromagnetic radiation only across other spectral bands (e.g., NIR, 750-1400 nm; SWIR, 1400-3000 nm; etc.). Multi-spectral imaging may allow for the extraction of additional information from the radiance received at a satellite after being reflected from the Earth's surface (which may include atmospheric effects such as from aerosols, clouds, etc.).

As discussed previously, there are generally few global data sets available that could be used to map the human settlements, much less high resolution satellite image data sets (e.g., HR, VHR) that could be used to do so. For instance, current global data sets (e.g., MODIS 500 m, LANDSCAN™, N LCD 2006, Corine Land Cover 2006, etc.) have the tendency to under-represent small, scattered rural settlements due to their low spatial resolution (e.g., between 50 and 2,000 m). Furthermore, the data sets represent single snap-shots in time that do not allow for regular monitoring. Still further, if the data sets are updated, they are typically not directly comparable due to changing input sources.

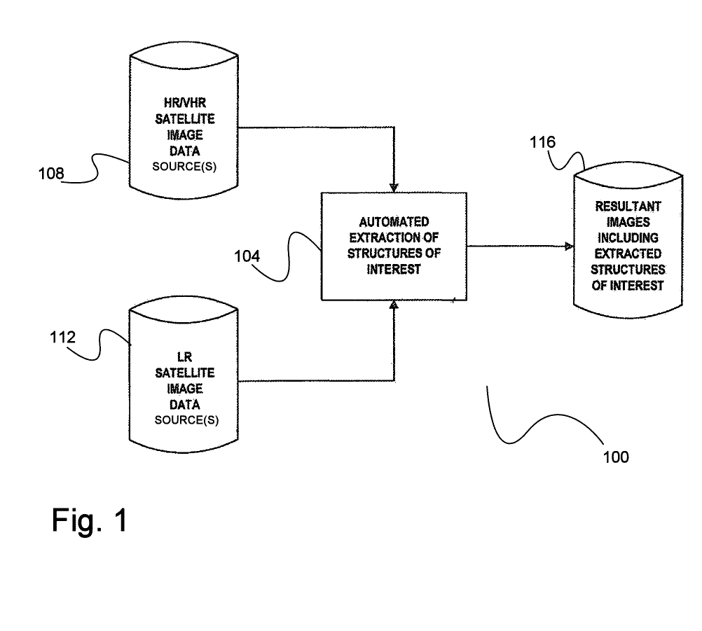

In this regard, FIG. 1 presents a simplified block diagram of a system 100 that may be used to generate and map regionally and globally consistent structures of interest such as human settlements (e.g., including built-up structures) within the time constraints and data constraints (e.g., in relation to resolution, volume, quality, etc.) typical of crisis management scenarios and the like. At the heart of the system 100 may be the automated extraction 104 of structures of interest from HR/VHR satellite image data source(s) 108 (e.g., <I-10 m spatial resolution satellite image data obtained by a number of heterogeneous platforms such as SPOT 2 and 5, CBERS 2B, RapidEye 2 and 4, IKONOS® 2, QuickBird 2, WorldView 1 and 2) and generation of resultant images 116 that include the extracted structures of interest therein. The automated extraction 104 may use data from LR satellite image data source(s) 112 (e.g.,) 10 m spatial resolution, such as MODIS 500 m, LANDSCAN™, etc.), for use in obtaining samples of the HR/VHR satellite image data 108 that will be used to train a hierarchical data structure for classifying and thus extracting structures of interest from the HR/VHR satellite image data 108.

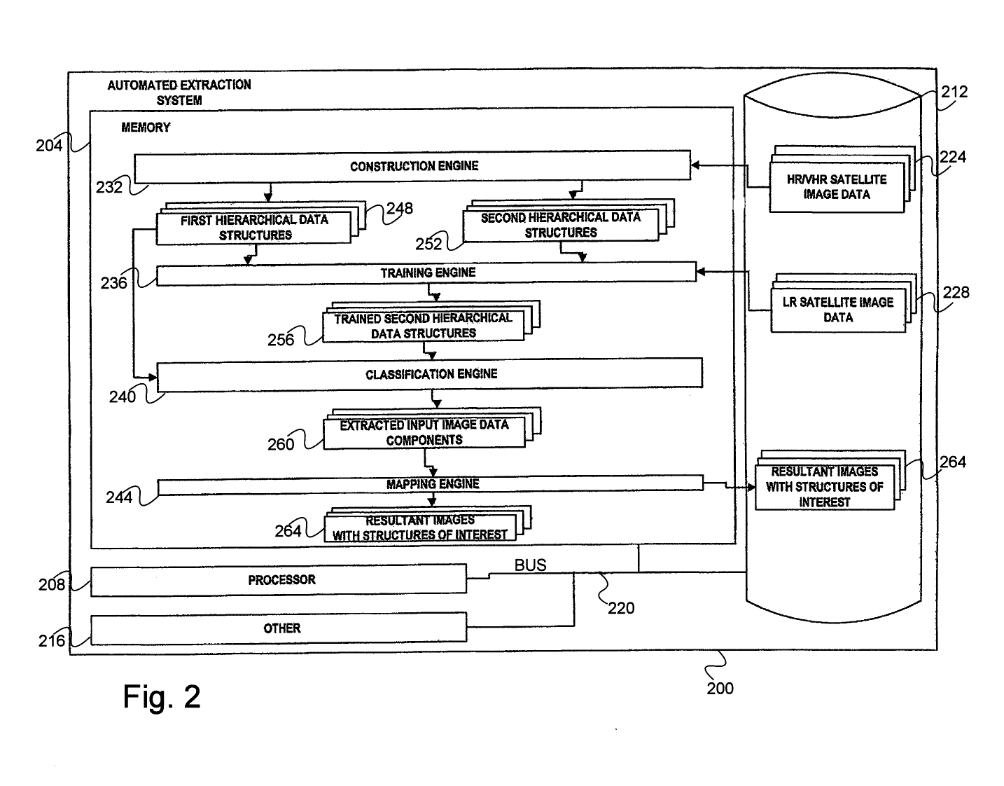

Turning now to FIG. 2, a more detailed block diagram of an automated extraction system 200 that may be used to implement the automated extraction 104 of structures of interest shown in FIG. 1 is presented. Although depicted as a single device (e.g., server, workstation, laptop, desktop, mobile device, and/or other computing device), one or more functionalities, processes or modules of the system 200 may be allocated or divided among a plurality of machines, devices and/or processes which may or may not be embodied in a single housing. In one arrangement, functionalities of the server 200 may be embodied in any appropriate cloud or distributed computing environment.

Broadly, the system 200 may include memory 204 (e.g., one or more RAM or other volatile memory modules, etc.), a processing engine or unit 208 (e.g., one or more CPUs, processors, processor cores, or other similar pieces of hardware) for executing computer readable instructions from the memory 204, storage 212 (e.g., one or more magnetic disks or other non-volatile memory modules or on-transitory computer-readable mediums), and/or a number of other components 216 (e.g., input devices such as a keyboard and mouse, output devices such as a display and speakers, and the like), all of which may be appropriately interconnected by one or more buses 220. While not shown, the system 200 may include any appropriate number and arrangement of interfaces that facilitate interconnection between the one or more buses 220 and the various components of the system 200 as well as with other devices (e.g., network interfaces to allow for communication between the system 200 and other devices over one or more networks, such as LANs, WANs, the Internet, etc.).

The system 200 may retrieve any appropriate HR/VHR satellite image data 224 (e.g., from one or more HR/VHR satellite image data sources 108 of FIG. 1) as well as any appropriate LR satellite image data 228 (e.g., from one or more LR satellite image data sources 112 of FIG. 1) and store the same in any appropriate form in storage 212 (e.g., such as in one or more databases and manageable by any appropriate database management system (DBMS) to allow the definition, creation, querying, update, and administration of the databases). The processing engine 208 may execute a DBMS or the like to retrieve and load the HR/VHR satellite image data 224 and/or LR satellite image data 228 into the memory 204 for manipulation by a number of engines or modules of the system 200 as will be discussed in more detail below.

As shown, the system 200 may include a “construction” engine 232 that is broadly configured to construct first and second hierarchical data structures from input satellite images, a “training” engine 236 that is broadly configured to train the second hierarchical data structure to detect the components of structures of interest in the first hierarchical data structure, a “classification” engine 240 that is broadly configured to employ the trained second hierarchical data structure to detect structures of interest in the first hierarchical data structure, and a “mapping” engine 244 that is broadly configured to transfer the components classified as being of interest into a resultant image. Each of the engines (and/or other engines, modules, logic, etc. disclosed and/or encompassed herein) may be in the form of one or more sets of computer-readable instructions for execution by the processing unit 208 and that may be manipulated by users in any appropriate manner to perform automated extraction and presentation of structures of interest (e.g., built-up layers or the like) on a display (not shown). In this regard, the combination of the processor 208, memory 204, and/or storage 212 (i.e., machine/hardware components) on the one hand and the various engines/modules disclosed herein in one embodiment create a new machine that becomes a special purpose computer once it is programmed to perform particular functions of the extraction utilities disclosed herein (e.g., pursuant to instructions from program software).

In one arrangement, any appropriate portal in communication with the various engines may run on the system 200 and be accessible by users (e.g., via any appropriate browser) to access the functionalities of the system 200. While the various engines have been depicted in FIG. 2 as being separate or distinct modules, it is to be understood that the functionalities or instructions of two or more of the engines may actually be integrated as part of the same computer-readable instruction set and that the engines have been depicted in the manner shown in FIG. 2 merely to highlight various functionalities of the system 200. Furthermore, while the engines have been illustrated as being resident within the (e.g., volatile) memory 204 (e.g., for execution by the processing engine 208), it is to be understood that the engines may be stored in (e.g., non-volatile) storage 212 (and/or other non-volatile storage in communication with the system 200) and loaded into the memory 204 as appropriate.

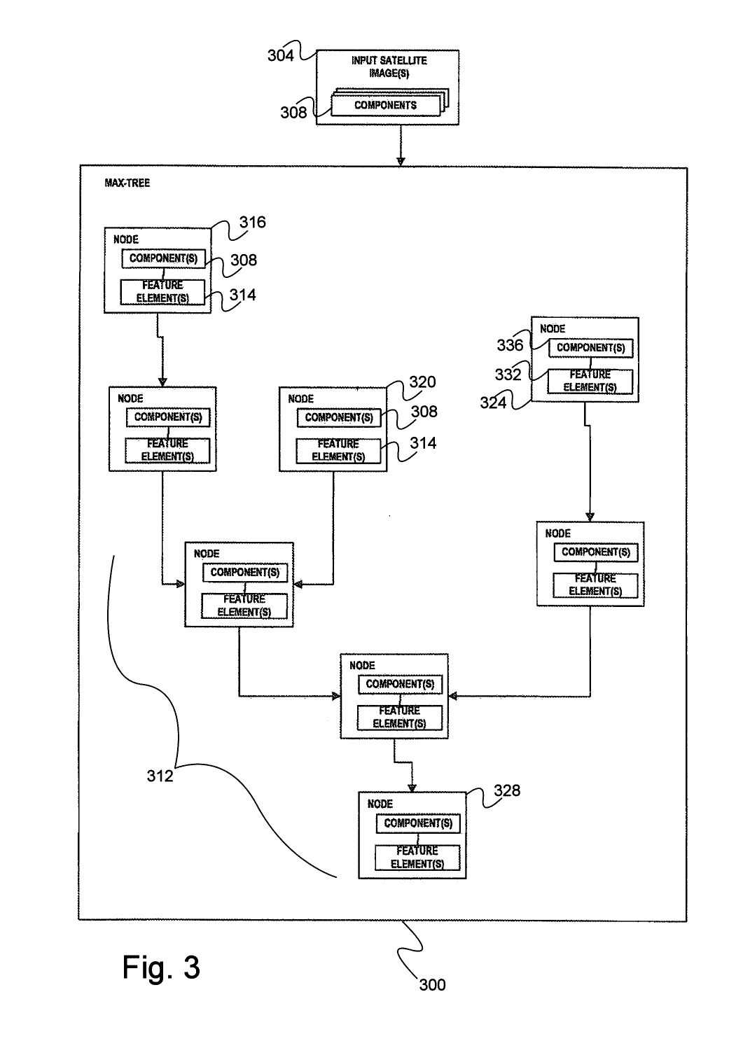

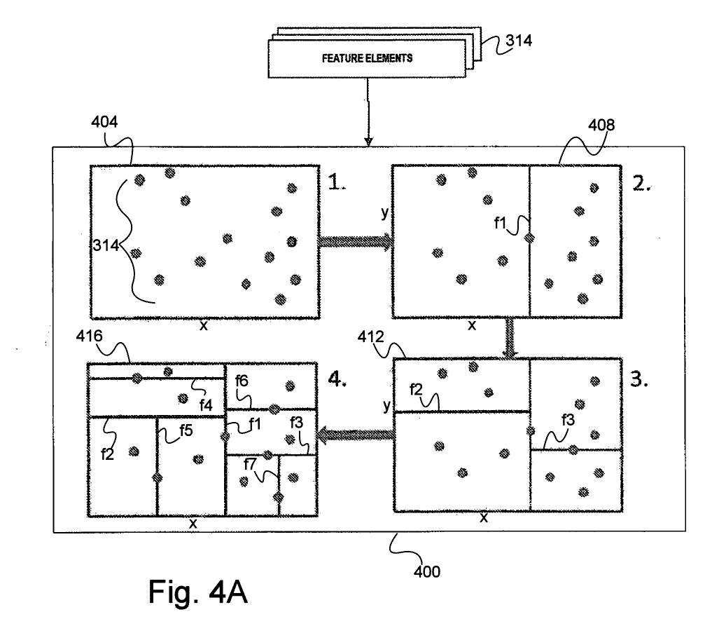

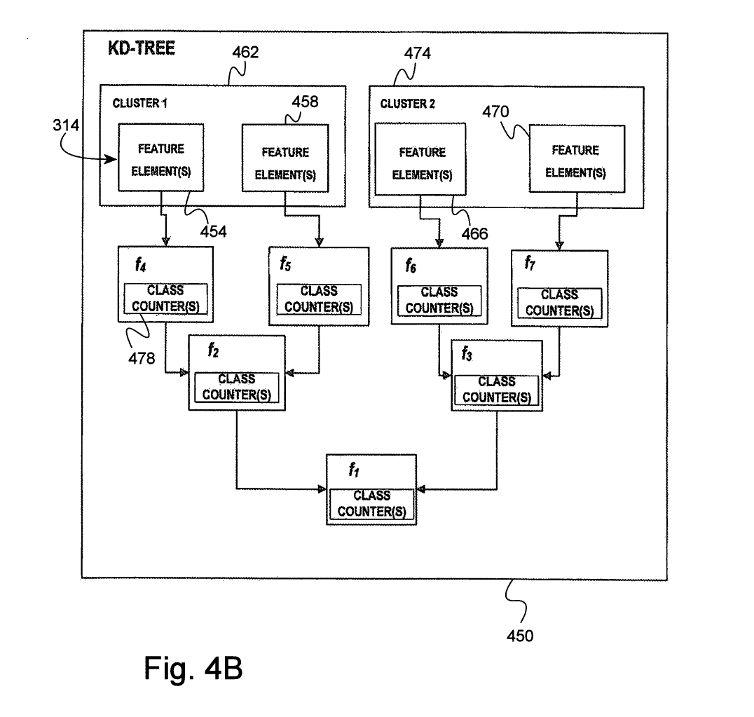

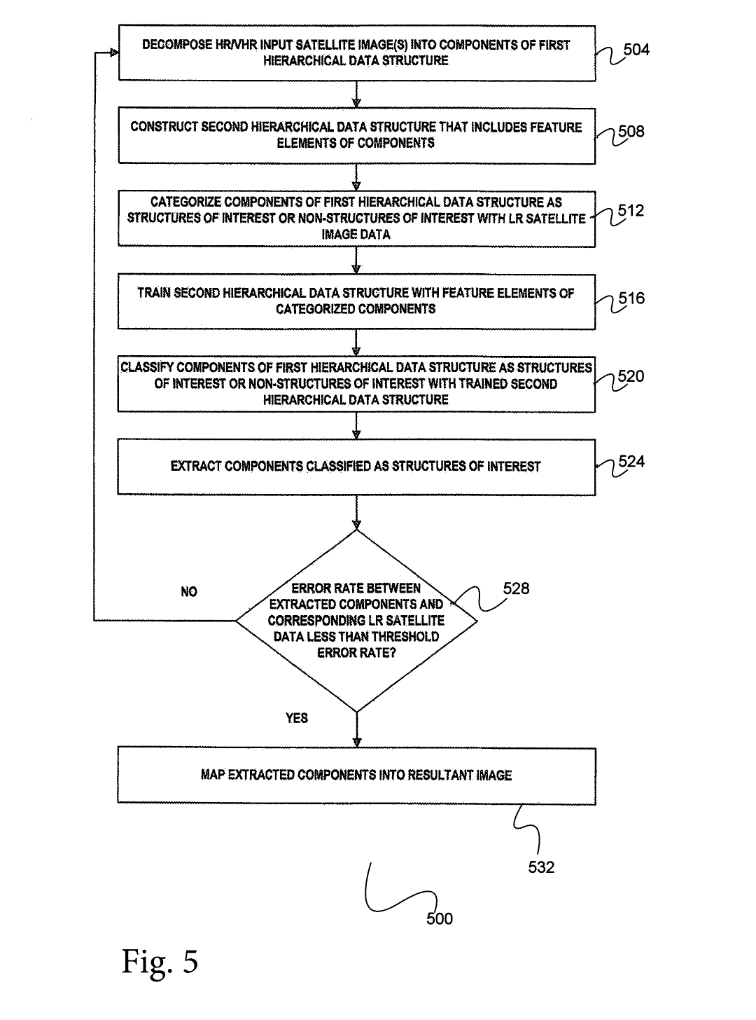

To facilitate the reader's understanding of the various engines of the system 200, additional reference is now made to FIG. 5 which illustrates a method 500 for use in performing the automated extraction processes disclosed herein as well as to FIGS. 3, 4a and 4b which respectively illustrate a Max-Tree and a KD-Tree for use in organizing data as part of the method 500 of FIG. 5. While specific steps (and orders of steps) of the method 500 have been illustrated and will be discussed, other methods (including more, fewer or different steps than those illustrated) consistent with the teachings presented herein are also envisioned and encompassed within the present disclosure.

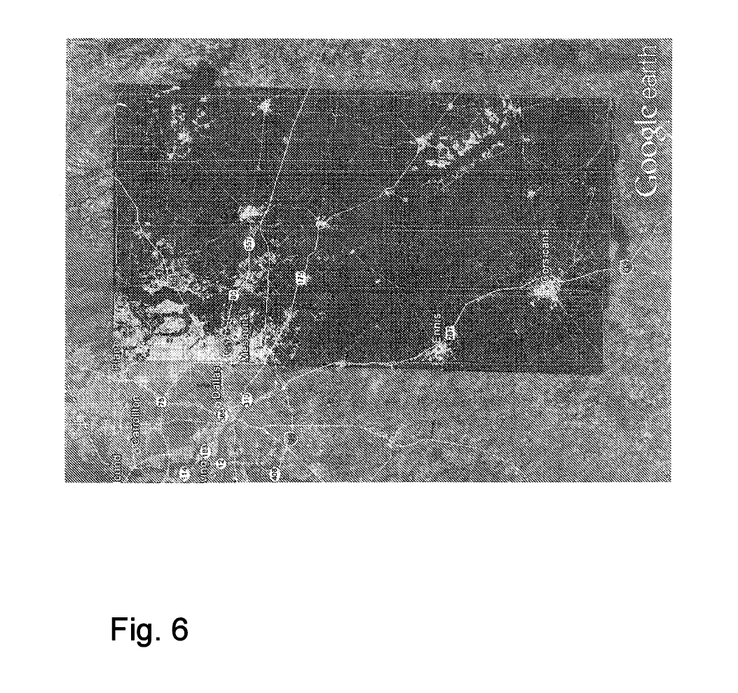

The method 500 may begin by decomposing 504 one or more HR/VHR input satellite images of a particular geographic area into a plurality of connected components (e.g., groups of pixels that collectively define the input images as whole) of a first hierarchical data structure. With reference to FIGS. 2 and 3, for instance, the construction engine 232 of the automated extraction system 200 may receive one or more input satellite images 304 (e.g., HR/VHR satellite image data 224) of a particular geographic area (e.g., WorldView 2 multispectral images acquired over a portion of Texas near Dallas, Tex. as shown in FIG. 6) and break the input images 304 down into a plurality of components 308. The construction engine 232 then appropriately organizes or arranges the various components 308 of the input images 304 into a first hierarchical data structure 248 such as a Max-Tree 300 made up of a plurality of hierarchically interconnected nodes 312, where each node 312 includes one or more of the components. Part of organizing the components 308 into the Max-Tree 300 also includes appropriately determining or otherwise obtaining feature elements 314 (e.g., k-dimensional descriptors) for each component 308 such as contrast, area, compactness, linearity, average spectral response, eccentricity and/or inertia for the component. The various feature elements 314 of each component 308 may be appropriately organized into a feature element or attribute vector for the component 308.

In the case of a multi-spectral image, for instance, the various spectral bands may be fused into a single band in any appropriate manner before the image is decomposed into the first hierarchical data structure. For example, the spectral bands of an 8-band multi-spectral image may be fused into a single band by way of the following built-up (BU) index which may be computed for each pixel of the input image:

$$BU = \frac{RE - NIR 2}{RE + NIR 2}$$

where “RE” is the intensity of electromagnetic radiation received in the red edge band of the electromagnetic spectrum, and “NIR2” is the intensity of electromagnetic radiation received in the NIR2 band of the electromagnetic spectrum. In this regard, the pixels of the 8-band multispectral image may be broken and arranged into a plurality of hierarchical components based on the respective BU values of the pixels.

As another example, the spectral bands of a 4-band multi-spectral image may be fused into a single band by way of the following built-up (BU) index which may be computed for each pixel of the input image:

$$BU = \frac{R - NIR}{R + NIR }$$

where “R” is the intensity of electromagnetic radiation received in the red band of the electromagnetic spectrum, and “NIR” is the intensity of electromagnetic radiation received in the NIR band of the electromagnetic spectrum. In this regard, the pixels of the 4-band multispectral image may be broken and arranged into a plurality of hierarchical components based on the respective BU values of the pixels.

In one arrangement, the Max-Tree 300 may be a rooted, unidirected tree with its leaves (e.g., leaves 316, 320, 324) corresponding to a regional maxima of the input images 304 and its root (e.g., node 328) corresponding to a single connected component defining the background of the input images 304. For instance, the hierarchical ordering of the nodes 312 may encode the nesting of peak components (e.g., pixels with intensities greater than a level “h”) with respect to the grayscale range of the input images 304. The image may be thresholded at each grey level to provide as many binary images as the number of grey levels. Each binary image may then be analyzed to derive its connected components. Each node 312 may generally point to its parent (i.e., the first ancestor node 312 below the given level) while the root node 328 points to itself. In one embodiment, each node 312 may include a pointer to a data structure that stores auxiliary data for each node 312. The construction engine 232 may compute or otherwise determine the feature elements 314 from such auxiliary data. The Max-Tree 300 may thus allow for compact storage of the connected components from all grey levels while having a limited computational complexity. In any case, the first hierarchical data structure(s) 248 (e.g., Max-Tree 300) may be appropriately stored in memory 204 for quick retrieval during subsequent steps of the method 500.

As shown in FIG. 5, the method 500 may then include constructing 508 a second hierarchical data structure that includes a plurality of hierarchically-arranged nodes, where each of the feature elements 314 depends from one of the nodes. With reference to FIGS. 2 and 3, the construction engine 232 may obtain the various feature elements 314 of the nodes 312 (e.g., of the components 308), where each feature element lies in a two-dimensional (e.g., x, y) space, and construct a second hierarchical data structure 252 such as a KD-Tree. Constructed second hierarchical data structure(s) 252 may be appropriately stored in memory 204 for quick retrieval during subsequent steps of the method 500.

FIG. 4a illustrates a simplified KD-Tree-based space partitioning procedure 400 that may be used to build a (hierarchically-arranged) KD-Tree. In one arrangement, the feature elements 314 may be initially disposed at appropriate locations with respect to an x, y coordinate system as shown in a first step 404 of the procedure 400. As just one example, the x-axis may correspond to the area of each component (e.g., a ground area collectively represented by the image pixels making of the component) and the y-axis may correspond to the red color response of each component. The construction engine 232 may then create a root node f1 as shown in a second step 408 by splitting the feature elements 314 into two groups with a vertical line through the median x-coordinate of the feature elements 314. A similar procedure may then be performed to create child nodes f2, f3, as shown in a third step 412, only with respective horizontal lines through the respective median y-coordinates of the feature elements 314 on either side of the root node f1.

The splitting may then continue recursively to create leaf nodes f4, f5, f6, f7 as shown in a fourth step 416, where each leaf node f4, f5, f6, f7 contains a single feature element 314 or up to a maximum of “m” feature elements 314, where m may be appropriately designated in advance. FIG. 4b illustrates a simplified KD-Tree built from the nodes f1-f7 and feature elements 314 illustrated in the fourth step 416 of FIG. 4a. As shown, each of the feature elements 314 depends from at least one of the nodes 314. While a two-dimension space partitioning structure is illustrated in each of the steps of FIG. 4a, it is to be understood that more complicated space partitioning structures may be constructed to accommodate more than two dimensions of feature elements. For instance, all of the feature elements 314 may be fused together in the partitioning structure and then splitting may occur against the most varying dimension. The feature elements 314 may then be clustered with respect to their full description which is the concatenation of the shape descriptors plus the spectral averages.

Returning to FIG. 5, the method 500 may include categorizing 512 at least some components of the first hierarchical data structure as either structures of interest (e.g., built-up) or non-structures of interest (e.g., non-built-up) using LR satellite image data. With reference to FIG. 2, the training engine 236 of the automated extraction system 200 may receive one or more reference satellite image data sets (e.g., LR satellite image data 228) over a geographic area that overlaps the geographic area over which the one or more input satellite images 304 were obtained (e.g., Lebanon). For instance, FIG. 6 illustrates a graphical representation of an NLCD 2006 information layer over a portion of Texas near Dallas, Tex. (e.g., where more highly populated areas (e.g., around Mesquite, Ennis and Corsicana, Tex.) are represented by different colors than less populated areas (e.g., along highway 287 between Ennis and Corsicana, Tex.).

In one arrangement, the training engine 236 may derive training components from the plurality of components 308 of the first hierarchical data structure 248/300 to be subsequently used to train the second hierarchical data structure 252/450 as will be described below. As just one example, the training engine 236 may consider a particular component 308 (e.g., group of pixels of the one or more input satellite images 304) of the first hierarchical data structure 248/300 as being a “positive” example in the event that the particular component 308 falls mostly or completely within an urban area as indicated in a corresponding portion of the one or more reference satellite image data sets (e.g., the NLCD 2006 information layer of FIG. 6). In contrast, the training engine 236 may consider a particular component 308 of the first hierarchical data structure 248/300 as being a “negative” example in the event that a corresponding portion of the one or more reference satellite image data sets is mostly or completely devoid of urban areas. In one embodiment, components 308 of the first hierarchical data structure 248/300 may be appropriately weighted to indicate the relative degree to which corresponding portions of the one or more reference satellite image data sets do or do not indicate urban or built-up areas.

In any event, and once a group of training components has been obtained (e.g., a subset of the plurality of components 308 of the first hierarchical data structure 248/300, such as one or more small, limited, and/or random portions of FIG. 6 so as to limit computational costs), the method 500 includes training 516 the second hierarchical data structure 252/450 with the particular feature elements 314 of the trained or categorized components obtained in step 512 to obtained a trained second hierarchical data structure 256 (see FIG. 2). With reference to FIG. 3, assume for purposes of discussion that component(s) 308 of leaf node 320 was/were identified as positive (e.g., built-up) examples in the categorizing step 512. In this regard, the training engine 236 may obtain the particular feature element(s) 314 (e.g., particular contrast level, compactness, average spectral response, etc.) associated with the component(s) 308 of the leaf node 320 (e.g., as well as feature element(s) 314 of parent, grandparent, root nodes, etc. along a common leaf-path), identify any same or similar feature elements 314 in the second hierarchical data structure 252/450, and label (e.g., tag, flag, mark, note, etc.) the nodes along the respective leaf-paths of the identified feature elements 314 in the second hierarchical data structure 252/450 as being positive (e.g., built-up) feature elements and/or negative (e.g., non-built-up) feature elements in any appropriate manner.

For instance, each of the nodes f1-f7 of the second hierarchical data structure 252/450 may include respective positive and/or negative class counters 478 configured to convey whether or not (or a degree to which) the nodes f1-f7 are within the positive or negative class. In this regard, the training engine 236 may update (e.g., increment, add to, etc.) the positive class counters 478 of all nodes f1-f7 along the leaf-path (e.g., branch) within which is located one or more feature elements 314 that are the same as or similar to those of the training components 308. In contrast, the positive class counters 478 of those of the nodes f1-f7 not resident within leaf-paths of one or more feature elements 314 that are the same as or similar to those of the training components 308 may be left untouched, the positive class counters 478 may be appropriately updated (e.g., reduced), the negative class counters 478 may be updated (e.g., incremented, added to), and/or the like. A similar procedure may be performed for each feature element 314 of each of the training components 308.

In one arrangement, two or more of the feature elements 314 of the second hierarchical data structure 252/450 that are close enough with respect to some dissimilarity (e.g., that are in the same neighborhood or cluster) may be assigned the same class label (e.g., and the class counters 478 of the nodes of respective leaf-paths appropriately updated). Stated differently, the class label of a single feature element 314 can be propagated to all other elements in the cluster (e.g., and their respective nodes) at little to no further computational cost thus reducing the overall computational overhead.

With reference to FIG. 4b, for instance, assume that feature element(s) 454, 458 are disposed within a first cluster 462 while feature element(s) 466, 470 are disposed with a second cluster 474. Furthermore, assume the training engine 236 initially labeled feature element(s) 454 as being in the “positive” class due to a similarity to feature element(s) 314 of the training components 308 but did not initially label any of feature elements 458, 466, 470 as being in the positive class. In this regard, the training engine 236 may also label the feature element(s) 458 as being in the positive class due to the feature elements 454, 458 being within the first cluster 462. In one variation, the more feature elements 314 of a particular cluster that are initially labeled as being within the positive class, the greater degree to which feature elements 314 in the cluster that are not initially labeled as being within the positive class are subsequently labeled as being within the positive class. However, the training engine 236 may not label the feature element(s) 466, 470 as being in the positive class as the feature element(s) 466, 470 are not within the first cluster 462. Of course, the feature elements 314 of other training components 308 may still cause the feature element(s) 466, 470 to be labeled in the positive class.

Again with reference back to FIG. 5, the method 500 may include classifying 520 components of the first hierarchical data structure 248/300 as structures of interest (e.g., built-up) or non-structures of interest (e.g., non-built-up) with the trained second hierarchical data structure 256. For instance, the classification engine 240 of the automated extraction system 200 (see FIG. 2) may identify those of the nodes f1-f7 of the trained second hierarchical data structure 256 whose class counters 478 indicate the node as being within the positive class (e.g., as being associated with structures of interest, such as built-up). In one arrangement, any appropriate thresholds or the like may be employed to allow the classification engine 240 to quickly identity those of the nodes f1-f7 in the positive class (e.g., class counters above or below one or more particular thresholds). In any case, the classification engine 240 may then identify the feature elements 314 depending from the leaves of each of the positively identified nodes f1-f7 and use the identified feature elements 314 to classify components 304 of the first hierarchical data structure 300 as being structures of interest (e.g., positive class, built-up) or non-structures of interest (e.g., negative class, non-built-up).

With reference to FIG. 3, for instance, assume that feature element(s) 332 of node 324 of the first hierarchical data structure 300 is or are the same or similar to a feature element 314 from the second hierarchical data structure 450 that depends from a leaf node of a positively identified node. In this regard, the classification engine 240 may classify component 336 of node 324 as being or identifying a structure of interest (e.g., an urban area). A similar process may be performed for other feature elements 314 associated with positively identified nodes from the second hierarchical data structure 450. Furthermore, other nodes 312 disposed along the same path or branch as the initially classified node 324 may also be classified as being structures of interest. While not discussed in more detail, a similar process may be performed to classify certain components 308 as being non-structures of interest.

It is to be understood that this discussion has been greatly simplified and has merely been provided to assist the reader in understanding the functionalities disclosed herein. Furthermore, numerous variations and more complicated arrangements are envisioned. For instance, one arrangement envisions that more than a particular threshold number of feature elements 314 of a particular node 312 of the first hierarchical data structure 300 must be labeled as structures of interest (e.g., two or more, three or more, etc.) before the corresponding component(s) 336 of the node 312 can be classified as being a structure of interest. In another arrangement, certain of the nodes 312 and/or components 308 may be appropriately clustered, grouped or the like (e.g., as discussed in relation to the second hierarchical data structure 252/450). In this regard, classification of one component 308 in a certain regard may result in similar classification of other clustered components 308.

In one variation, the categorizing 512 may be recursively performed with respect to additional portions of the plurality of components 308 of the first hierarchical data structure 248/300 to further refine the accuracy of the training 516 and classifying 520. For instance, a second subset of the components 308 of the first hierarchical data structure 248/300 (e.g., corresponding to one or more different, partially or fully non-overlapping portions of Texas in FIG. 6) may be categorized as structures of interest or non-structures of interest using corresponding portions of the reference satellite image data set (e.g., the NLCD 2006 of FIG. 6) to derive additional “training components” from the first hierarchical data structure 248/300. Thereafter, the second hierarchical data structure 252/450 may be trained 516 as discussed previously with the feature elements 314 of the second subset (e.g., with the additional training components) and then (all) of the components 308 of the first hierarchical data structure 248/300 may be classified/reclassified as being structures of interest or non-structures of interest.

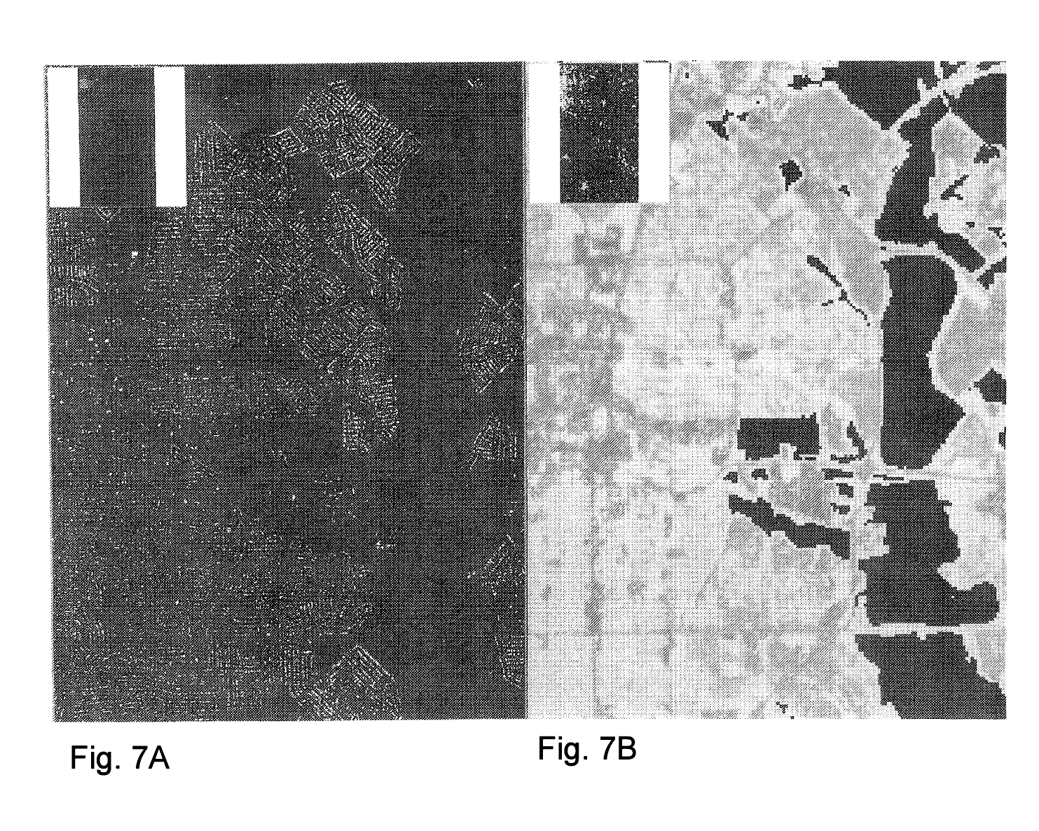

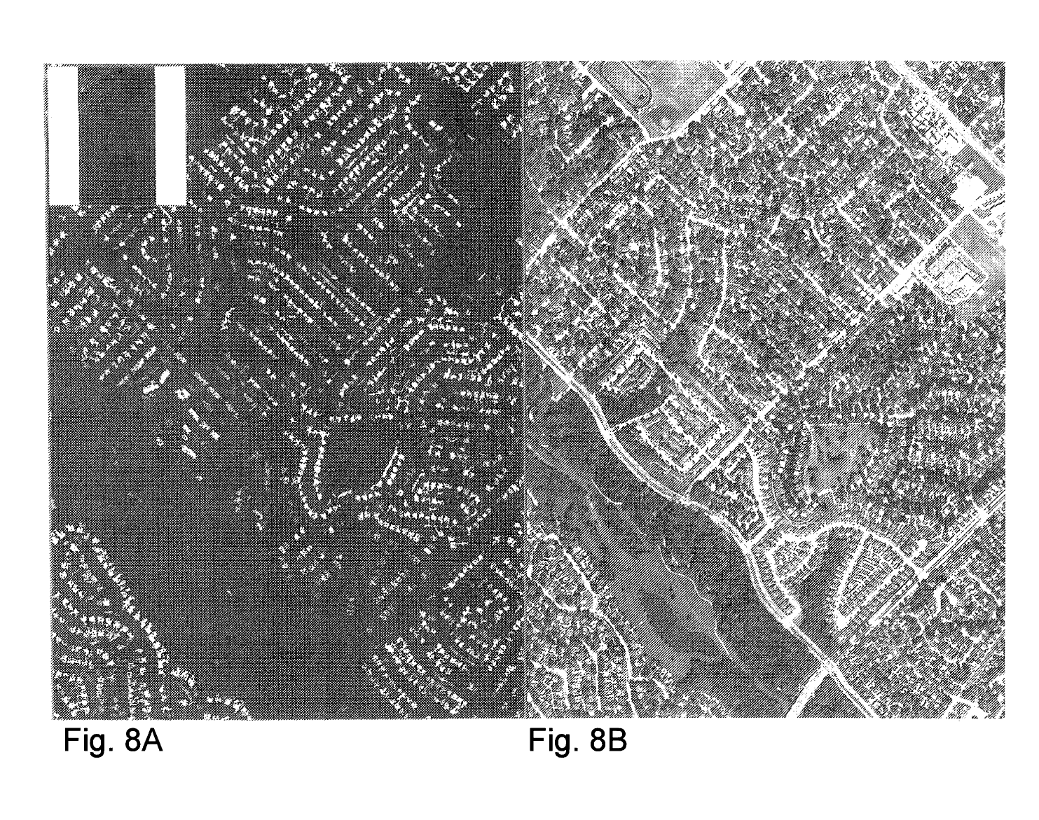

As shown in FIG. 5, the method 500 may then include extracting 524 (e.g., isolating, obtaining, etc.) components (e.g., see extracted components 260 in FIG. 2) that are classified as identifying structures of interest from the classifying step 520 and querying 528, for each respective extracted component 308, whether an error rate (e.g., EERs) between the extracted component and a corresponding portion of a reference satellite image data set (e.g., LR satellite image data associated with the subject geographic area and having a spatial resolution lower than that of the input satellite images 304) is less than a particular threshold error rate. The reference satellite image data set used to determine the error rates may be the same as or different than the reference satellite image data set used in the categorizing step 512. Those extracted components 308 associated with error rates below the threshold error rate may be mapped 532 (e.g., via mapping engine 244) into a resultant image (e.g., resultant image 264) that includes the structures of interest (e.g., at a spatial resolution greater than that of the reference satellite image data set(s), such as at least substantially the same as that of the input image(s) 304). For instance, see FIGS. 7a and 8a which present a result of the mapping step 532 over a portion of Texas at respective first and second levels of zoom. Resultant images 264 may be appropriately stored in both (volatile) memory 204 and (non-volatile) storage 212.

As an example, cloud cover or the like when the input satellite image(s) 304 was/were obtained may result in error rates above the threshold for extracted components classified as identifying built-up structures. In this regard, such extracted components may be not mapped into the resultant image or at least mapped into the resultant image to a lesser degree (e.g., assigned a lower weight based how far over the threshold were the corresponding error rates). However, the decomposing 504, constructing 508, categorizing 512, training 516, classifying 520, extracting 524, querying 528 and mapping 532 may be performed with respect to subsequent input satellite images (e.g., second, third, etc.) over the substantially same geographic area that are obtained via heterogeneous sources, different satellites, different locations, different times such as multi-temporal images, different frequencies or wavelengths such as multispectral images, and/or the like. Incorporation of additional input satellite images into the method 500 may increase the likelihood that those portions of the resultant image that would otherwise be depicting built-up (but for the corresponding previously extracted components not being mapped into the resultant image due to error rates over the threshold) do eventually depict corresponding built-up portions (e.g., due to the subsequent/additional input satellite images being obtained from a high azimuth, during a partially or fully cloudless, sunny day, etc.) to allow for an iterative refinement of the resultant image (e.g., the images presented in FIGS. 7a and 8a) over a plurality of cycles. While the method 500 has been discussed as including the querying step 528, some arrangements envision proceeding from the extracting step 524 directly to the mapping step 532 without performing the querying step 528 (e.g., to reduce computational costs, such as time, resources, etc.).

### Non-Limiting Example

Four WorldView-2 8-band multispectral images acquired over a portion of Texas near Dallas, Tex. as shown in FIG. 6 are considered. Max and KD-Trees (e.g., first and second hierarchical data structures) are obtained as discussed previously with respect to steps 504 and 508 of FIG. 5. Samples from the globally-consistent NLCD 2006 information layer shown in FIG. 6 are systematically collected (where the data was collected from orbiting Landsat satellites at a spatial resolution of 30 meters). In the case of the multispectral scenes of FIG. 6 containing 10070×58734 pixels, components can arranged into a Max-Tree (e.g., as in FIG. 3) and then a corresponding KD-Tree (e.g., as in FIG. 4b) can be generated in about 387 s. Subsequently, training components are derived considering the NLCD 2006 information layer (e.g., step 512 of FIG. 5) in about 23 s before being used for training the KD-Tree in under 1 s (step 516 of FIG. 5). The classification (e.g., step 520 of FIG. 5) is then obtained in well under 1 s (e.g., much closer to 0 s than to 1 s) before components identifying built-up are extracted and reprojected in (e.g., mapped into at step 532 of FIG. 5) the image space. The result of this process on the WorldView-2 multispectral scenes is displayed in FIGS. 7a and 8a. FIGS. 7b and 8b respectively illustrate close-up portions of the NLCD 2006 and WV2 multispectral images corresponding to the resultant images of FIGS. 7a and 8a.

At low spatial resolutions (e.g., satellite image data obtained from Landsat 30 m sensor, MODIS 500 m sensor, etc.), spectral measurements can calibrated such that they are not affected by the sun, satellite angles, atmospheric conditions, and the like. In this regard, LR satellite image data can be used to accurately classify structures of interest in HR/VHR satellite image data as disclosed herein. In one arrangement, the utilities disclosed herein may be used to generate a globally consistent HR/VHR satellite image layer that includes structures of interest (e.g., built-up) and that is devoid of non-structures of interest. The globally-consistent layer can be used in numerous contexts such as in assessing population densities, qualities of life, vulnerability factors, disaster risks, sufficiency of civil infrastructures, economic growth, poverty levels, event monitoring and evolution, and the like.

It will be readily appreciated that many deviations and/or additions may be made from or to the specific embodiments disclosed in the specification without departing from the spirit and scope of the invention. In one arrangement, it is envisioned that different structures of interest (e.g., different types of built-up) may be differently shaded, colored, and/or the like (e.g., such as based on one or more geometric and/or radiometric attributes of pixels or components of the resulting image) in the resulting image to allow analysts to be able to quickly analyze the resulting image. As an example, the mapping engine 264 may analyze the feature elements 314 of the extracted input image components to determine a type of built-up structure represented by the particular component(s). For instance, buildings may exhibit one general type of feature element “signature” while tents may exhibit another type of feature element signature. The mapping engine 264 may have access to a database that correlates feature element signatures with respective colors, shades, and/or the like. During the mapping of the extracted components into the resulting image, the mapping engine 264 may access the database and implement the colors, shades, etc. as appropriate.

In another arrangement, it is envisioned that manual (e.g., analyst) input may replace or at least supplement categorizing step 512 of FIG. 5. For instance, it is envisioned that a user may be able to manually select (e.g., on a display with any appropriate user manipulable device) one or more positive training regions (e.g., representing structures of interest) of the input satellite image and/or one or more negative training regions (e.g., not representing structures of interest) of the input satellite image. The feature elements of the components of the first hierarchical data structure representing the selected regions may then be used to train 516 the second hierarchical data structure before components are appropriately classified in step 520. For example, the user may continue to select different training regions/examples after each classification step 520. In one variation, it is envisioned that a user may manually selected at least some positive and negative training regions/components and then a reference data set (e.g., NLCD 2006) may be used to identify other training regions/components.

In a further arrangement, a plurality (e.g., a “forest”) of second hierarchical data structures (e.g., KD-Trees) may be constructed and trained for use in classifying and thus extracting different types of structures of interest from input satellite images. As one example, a first KD-Tree may be generated with a first set of feature elements of the first hierarchical data structure and a second KD-Tree may be generated with a second set of feature elements of the first hierarchical data structure that is at least partially non-overlapping with the first set of feature elements (e.g., the first set includes contrast, compactness and linearity values of each of the components of the first hierarchical data structure and the second set includes compactness, linearity and average spectral response of each of the components of the first hierarchical data structure). Thereafter, training components may be selected in any appropriate manner from the first hierarchical data structure (e.g., with one or more low resolution information layers as discussed herein, via manual input, and/or the like) and their respective feature elements used to train each of the first and second KD-Trees to be able to detect particular types of structures (e.g., particular types of built-up) in at least one input satellite image. The first and second (e.g., and/or additional) KD-Trees may then be used to classify particular objects/areas/regions of the at least one input satellite image which may then be extracted and incorporated into a resultant image.

As another example, it is envisioned that a single second hierarchical data structure (e.g., a single KD-Tree) that includes all of the feature elements from the first hierarchical data structure may be initially constructed as disclosed herein (e.g., via fusing all of the feature elements together in the partitioning structure and then performing the splitting against the most varying dimension). Thereafter, however, a plurality of copies of the KD-Tree may be made to create a “forest” of KD-Trees, where each copy may be trained to detect different objects/areas/etc. in the at least one input satellite image. For instance, one or more training components representing positive and/or negative examples of a first type of object/structure/area of the first hierarchical data structure may be selected from the first hierarchical data structure in any appropriate manner (e.g., with one or more low resolution information layers as discussed herein, via manual input, and/or the like) and their feature elements used to t rain a first of the KD-Tree copies to detect the first type of object/structure/area. Additionally, one or more different training components representing positive and/or negative examples of additional types of objects/structures/areas of the first hierarchical data structure may be selected from the first hierarchical data structure in any appropriate manner (e.g., with one or more low resolution information layers as discussed herein, via manual input, and/or the like) and their feature elements used to train additional ones of the KD-Tree copies to detect the additional types of objects/structures/areas. In one variation, different low resolution information layers may be used to identify different types of training components from the first hierarchical data structure. The various differently-trained KD-Trees may then be used to classify particular objects/areas/regions of the at least one input satellite image which may then be extracted and incorporated into one or more resultant images.

Furthermore, while the first hierarchical data structure has been discussed primarily in form of a Max-Tree, is it envisioned that other forms of the first hierarchical data structure may be used with the utilities disclosed herein. In one arrangement, the first hierarchical data structure may be in the form of an “Alpha-Tree” whereby pixels of the input satellite image (e.g., intensity values, radiance values, BU values, etc.) may be hierarchically grouped into components (e.g. nodes) based on any appropriate measure of dissimilarity between adjacent nodes. Thereafter, the second hierarchical data structure may be constructed from feature elements (e.g., attribute vectors) of the components/nodes of the Alpha-Tree, training components/nodes of the Alpha-Tree may be selected, the second hierarchical data structure may be trained, the components/nodes of the Alpha-Tree may be classified, and structures of interest may be extracted from the input image and displayed in a resultant image as disclosed herein.

Embodiments disclosed herein can be implemented as one or more computer program products, i.e., one or more modules of computer program instructions encoded on a computer readable medium for execution by, or to control the operation of, data processing apparatus. For example, the logic or software of the construction engine 232, training engine 236, classification engine 240 and mapping engine 244 responsible for the various functionalities disclosed herein may be provided in such computer-readable medium of the automated extraction system 200 and executed by the processor 208 as appropriate. The computer-readable medium can be a machine-readable storage device, a machine-readable storage substrate, a non-volatile memory device, a composition of matter affecting a machine-readable propagated signal, or a combination of one or more of them. In this regard, the system 200 may encompass one or more apparatuses, devices, and machines for processing data, including by way of example a programmable processor, a computer, or multiple processors or computers. In addition to hardware, the system 200 may include code that creates an execution environment for the computer program in question, e.g., code that constitutes processor firmware, a protocol stack, a database management system, an operating system, or a combination of one or more of them.

### Description of Architecture for Crowdsourced Image Analysis

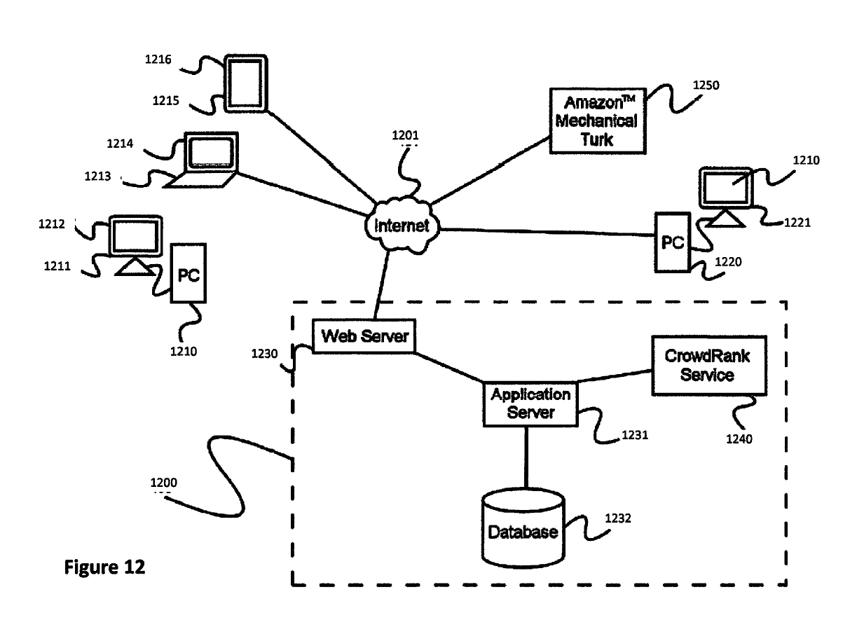

FIG. 12 is a diagram of an exemplary architecture for a platform 1200 for crowdsourced image analysis, according to a preferred embodiment of the invention. According to the embodiment, crowdsourcing is accomplished by distributing image analysis tasks to various participant users, who typically access platform 1200 via Internet 1201 from tablet devices 1215, laptops 1213, personal computers 1210 with monitors 1211, or other Internet-accessible computing devices. Access to platform 1200 is typically, although not necessarily, made using a browser 1212, 1214, 1216 (or a similar Internet-connected software application). As is typical of Web applications, platform 1200 may be accessed by participating users via web server 1230, which may comprise web server software such as Microsoft Internet Information Server, Apache Web Server, IBM Websphere Web Server, or any other web server known in the art, stored and operating on a single network-attached server computer or a cluster of server computers, or it may comprise such software operating on a plurality of such machines, and may be placed behind a load balancer (not shown) that distributes requests among the various instances of web server 1230. As is typical of Web applications, participant user requests pass from browsers 1212, 1214, 1216 via Internet 1201 to web server 1230, which stores and returns static web page elements locally, and passes application-specific requests to application server 1231. Application server 1231 may be any particular form of application server known in the art, such as Apache Tomcat or Geronimo, Java Platform Enterprise Edition, RedHat JBoss AS, Windows Server, or IBM WebSphere Application Server; further, it will be understood by one having ordinary skill in the art that this list is merely exemplary and is in no way limiting. Application server 1231 may comprise application server software stored and operating on a single network-attached server computer, or it may comprise such software operating on a plurality of such machines, and may be placed behind a load balancer (not shown) that distributes requests among the various instances of application server 1231. As is common in the art, application server 1231 uses a database 1232 to store application-specific data. Typically (although not necessarily), application server 1231 will offer a stateless representation state transfer (REST) application programming interface (API) to users via web server 1230, and accordingly all application state data is maintained in database 1232, which facilitates scalable operations (since each application server 1231 instance is not required to maintain state information separately, and since the need for complex state propagation between application servers is thereby eliminated. Of course, it will be appreciated by one having ordinary skill in the art that the general architecture of a web server 1230 coupled to an application server 1231 via a REST API, with database 1232 storage of application data, is typical of scalable web applications but is also merely exemplary. It may be desirable in some cases for a client-server connection between dedicated applications 1212, 1214, 1216 and a dedicated server software 1231 that uses a proprietary interface and could even be a stateful server application.

With this basic architecture in mind regarding the connections between participating users and application server 1232, specific aspects of the invention will now be described. Before participating users can participate in a crowdsourcing campaign, a requesting entity must set up the campaign. Requesting entity (and administrative) users interact with application server 1231 via the Internet 1201 and web server 1230 just as participating users do; a single PC 1220 with monitor 1221 and browser 1222 is shown in FIG. 12 to represent administrative and requesting entity users (it should be noted of course that only PC 1220 is shown for brevity; as with participating users, administrative/requesting entity users may use any suitable Internet-capable computing device according to the invention). Requesting entity users will generally create and manage crowdsourced image analysis campaigns, and will view results of such campaigns (possibly adjusting the settings of such campaigns as a result of such reviews, to improve the performance of such campaigns). Once a campaign is set up, it may be activated by the requesting entity, at which point participating users may “join” the campaign and thereupon start receiving image analysis tasks associated with the campaign to perform. In a preferred embodiment, images are delivered form database 1232 to participating users by application server 1231 via web server 1230, and participating users interact with such images in web browsers 1212, 1214, 1216 using tools provided by application server 1232. In some embodiments, however, third party crowdsourcing platforms such as Amazon's Mechanical Turk 1250 may be used to manage a crowdsourced image analysis campaign using images and requirements provided by application server 1231 or directly from database 1232.

As noted above in the background section, one common challenge in search and locate problems, which is not addressed by current crowdsourcing techniques (which, as noted, use either or both of the work distribution with quality measurement and the democratic/voting techniques), is the problem of accurately finding and locating targets of interest using crowdsourcing. The shortcomings of the two main crowdsourcing approaches (work distribution and voting) are different for each approach. The work distribution approach is still useful in search and locate problems, but it is not adequate by itself, as it does not provide a means for locating targets of interest, particularly when many participating users “tag” the same target of interest, often with varying locations (generally nearby, but in some cases even quite distant from each other). The voting approach, while excellent for ranking reputations (is this a good song or not?) or for classification problems (is this a tank or not?), does not handle continuous variations of input data well. That is, voting is good when there is a small set of possible options (which is this: a dog, a cat, or a skunk?); the resulting tallies for each discrete element of the set can be compared and a “winner” selected (it's a cat). But when the input provided by participating users is not only the presence of an object but also its two-dimensional location (or even three-dimensional location), the simple voting approach does not help to answer the question, “where is it, really?”

Accordingly, in a preferred embodiment platform 1200 further comprises a CrowdRank service 1240, which may be stored and operating on a single network-attached server coupled to application server 1231. In some embodiments, CrowdRank service 1240 operates on a large number of independent machines whose activities may be coordinated using an approach such as the well-known map/reduce technique. CrowdRank service 1240 takes as inputs a (typically large) set of tags from many participating users. Fundamentally, CrowdRank service 1240 implements a CrowdRank algorithm (described in detail below) that attempts to determine a “most likely” set of targets that are present in an image, using a large amount of tagging data obtained from participating users viewing the same or related images. Because location tagging is an inherently noisy process (people vary widely, at a minimum; in addition, some viewers may view an image at higher resolution than others, while some may tag an extensive object at its centroid while others tag it at various points on its edges, and so forth). Therefore, it will usually be the case that tag data input to the CrowdRank service 1240 is very noisy; for example, if there are several targets of interest close to each other “in the real world” (i.e., in the place from which the image was taken, at the time the image was taken), the inevitable inaccuracies in users' tagging may result in (for example) a single cloud of nearby tags that might be interpreted as belonging to a single target of large extent but actually belongs to two or more “real” targets. The CrowdRank algorithm may optionally take as input one or more sets of prior data, for instance regarding the quality of a specific set of participating users' previous tagging work; such prior data may (as described below) be used to improve the time to convergence of the algorithm. In some embodiments, prior data may also be used to improve accuracy of the algorithm, instead of (or in addition to) improving its convergence time. For example, if a known-malicious user is given a prior that says he is a poor tagger, his input will be ignored instead of calculated into the mix. In some cases, the algorithm might not arrive at the conclusion that a particular user is malicious, but if his prior data suggests so, it may be more likely to be detectable by the algorithm. Given these inputs, the CrowdRank algorithm uses an iterative expectation-maximization process to generate, as outputs, three sets of data (although conventionally maximization processes are used after an expectation of maximum likelihood, it should be noted that, where convenient, the algorithm can be conducted using a numerical minimization approach by simply mapping variables in a corresponding way). The first is an array of quality scores for the taggers (the participating users who created tags as part of the crowdsourcing campaign whose data is being analyzed by the CrowdRank algorithm). The second is an array of difficulty scores for each tagged target. The third is an array of estimated locations of actual targets, comprising for each target data such as the latitude and longitude of the target, the type of the target (tank, railroad car, damaged building, debris field, etc.), and a confidence level in the identification.

Fundamentally, the CrowdRank algorithm is focused on identifying an underlying hidden variable (the real targets that existed at a time of interest) using incomplete data (the tagging data, which won't necessarily have tags for all of the real targets, and which may have many tags for each real target). In order to move from the inputs (principally tag data, each tag comprising a tag identifier, a tagger identifier, a location (latitude and longitude, or a UTM grid point and easting and northing values for the offset from that UTM grid point), the CrowdRank algorithm carries out a key data transformation, then uses a modified iterative expectation-maximization (EM) algorithm to generate a set of intermediate outputs, then performs a clustering on the interim outputs to arrive at the final CrowdRank output. The details will be described below, but at a high level the initial data transformation involves converting straightforward geolocation information (a series of tags generated by participating users) into a set of agreement/disagreement data (meaning agreement or disagreement among the participating users of the input set). Also, since EM algorithms known in the art take an input vector and a parameter vector and attempt to identify a vector corresponding to a hidden variable of which the input vector represents a (possibly noisy) subset, in the CrowdRank algorithm the vector of quality scores and the vector of difficulty scores are mathematically combined and treated as the parameter vector for EM algorithm purposes.

From a use case perspective, what is accomplished using platform 1200 includes: setting up (by requesting entities) image analysis campaigns; running the campaigns to generate tag sets from participating users; displaying the results to one or more requesting entity users; and using the CrowdRank algorithm with the results as input to generate an estimate of ground truth (that is, an estimate of the actual targets of interest and their locations) and displaying or disseminating the same to the requesting entity users (for example, by auto-generating kml/kmz files, and making the resulting output available via a REST API for consumption by users' workflows).

### Description of Crowdsourcing Method Embodiments

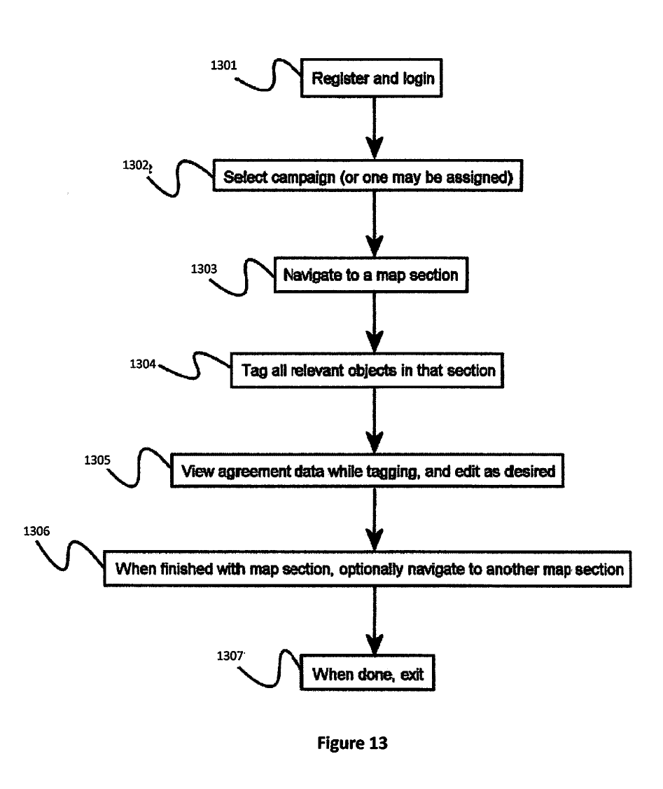

FIG. 13 is a process flow diagram of a method 1300 to allow a plurality of users to participate in crowdsourced image analysis, according to a preferred embodiment of the invention. According to the embodiment, in step 1301 a participating user may register with platform 1200 (thereby obtaining a user identifier), and once registered, may log in to platform 1200 in order to participate in one or more crowdsourced image analysis campaigns. It will be appreciated by one having ordinary skill in the art that there is a variety of information that may be obtained by platform 1200 during user registration, such as user name, user background, type of user (volunteer, paid, etc.), organizational membership, tagger group memberships, and the like. For example, a new user may register as a member of an organization that is focused on a particular campaign, set of campaigns, or type of campaigns (for example, a “league of armchair military analysts”, whose members focus only on military analysis, such as tracking developments in combat areas such as Syria or Mali); alternatively or also, a user may register as a member of one or more existing “tagger groups” (such as search and rescue, climate change damage assessment, and so forth). In some embodiments, “passive login”, such as logging in using FACEBOOK™ or MECHANICAL TURK™ credentials, may be provided; for example, a user may be logged in automatically with an identifier corresponding to his MECHANICAL TURK™ or FACEBOOK™ identifier, and the user would therefore not see a login process occurring. Once a participating user has logged in, he may be presented with a list of active campaigns for which he is eligible (campaigns may be unrestricted, meaning every registered user is eligible to participate, or they may be limited to participating users from specific organizations or tagger groups, or to participating users who satisfy some criterion such as experience level, average quality rating, MECHANICAL TURK™ qualification, etc.). Upon viewing such a list of available campaigns, in step 1302 the user may select a campaign in which he wishes to participate; alternatively, in step 1302 platform 1200 may automatically assign the user to a specific campaign upon login. In support of the selection process of step 1302 (when performed manually by a participating user), the user may be shown a list (using any of the many well-established user interface conventions for displaying lists from which selections are to be made) of available campaigns that the specific user may participate in. In some embodiments, some campaigns may be limited to certain classes or groups of participating users; for example, a sensitive law enforcement campaign may only be made available/visible to qualified law enforcement personnel (this may actually occur, for example, when a high-profile search for a target is needed, and law enforcement personnel from a wide variety of agencies may desire to assist informally, without sensitive information being divulged to the public at large). In some embodiments, campaigns may be assigned automatically by platform 1200 in step 1302, for instance where new participating users are assigned to a specific training campaign until they complete the required training or otherwise demonstrate proficiency.

Once a campaign has been selected by or for a participating user, in step 1303 the user may navigate to a specific map section to carry out tagging operations (that is, to attempt to identify and locate targets of interest in the map section to which the user has navigated). Again, as in campaign selection, in some embodiments automated action may be taken in step 1303, rather than allowing a user to manually select a map section for viewing. For example, it may be important that users are not provided information about the actual map location (that is, grid coordinates or latitude and longitude) of map sections as they view them and carry out tagging operations. In some cases, it may be important that users are unable to identify the actual, physical location of a target of interest on the earth's surface (for instance, to prevent looting of valuable archaeological sites). Accordingly, users may be “navigated” automatically in step 1303, by being shown successive map sections without their spatial locations or relationships being known. In some embodiments, platform 1200 may enforce a sampling regimen wherein various map segments are assigned probability levels (of having targets of interest in them) or interest levels, and the number of participating users who are encouraged or made to view specific map sections may vary accordingly (more users might be assigned to more interesting, promising, or difficult map sections). Similarly, in some embodiments users may be provided an option to manually navigate or to have the system navigate for them (for instance, they could be provided a “next” button, or a “surprise me” button, as well as a small map of an entire interesting region via which they can manually navigate by selecting a map segment using for example a computer mouse or a touchpad). Once a participating user is “in” (i.e., viewing) a particular map segment, the user tags all relevant objects (targets of interest) in that section in step 1304 (of course, it should be apparent that not all users will find all actual targets in any given map segment; skill, persistence, and interest level—among other variables—may cause some to tag only a subset, and others to tag false targets of interest, and so forth). In some embodiments, in step 1305 a participating user may view agreement data while tagging objects. For example, when a user moves a graphical cursor to a specific map location and selects an action (e.g., “tag as tank”), a graphical indicia may be displayed advising the user how many other users placed a similar tag there (or within a reasonable—and configurable—distance from the user's cursor location); in some embodiments, a second graphical indicia such, as a colored cursor, may be provided to indicate a position of the centroid of a set of other users' tags, effectively indicating to the participating user information such as, “ten other people tagged a tank, but the group locates the tank at this slightly different location”. Accordingly, users may be provided a means to edit their tags (for example, by clicking and dragging their tag onto the marked centroid position, or to adjust its position relative to an underlying image feature, as desired). When editing is completed in step 1305, a user may simply move on to make another tag, or may be provided with a positive confirmation means, such as a clickable “Tag” button, to indicate that a particular tag will no longer be edited, but a new tag may be placed in the current map segment. In some embodiments, some or all users may not be shown agreement data, for example to encourage “open minded” tagging by suppressing feedback from other users' activities.

In step 1308, once a participating user is finished tagging objects in a specific map section (typically, because either the user is bored with a particular map section, or the user believes she has tagged all targets of interest), the user may navigate to another map section (again, manually or automatically), and resume carrying out method 1300 in step 1304. In step 1307, when a user is finished, either because the user decides to complete their tagging session, or because a campaign setting is reached (for instance, a campaign might specify that no user should do more than ten map sections at a time), then in step 1309 the user exits method 1300 (typically by navigating away from the web page provided by platform 1200 for participating users).

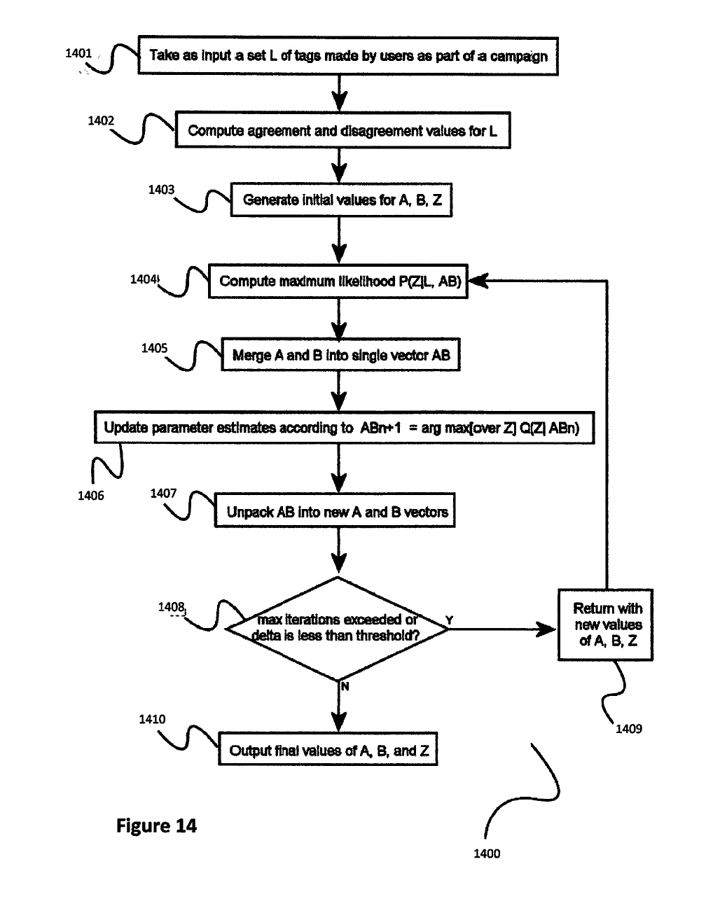

FIG. 14 is a process flow diagram of a method 1400 for estimating location and quality of a set of geolocation data based on tag data provided by a plurality of users of a crowdsourced image analysis platform of the invention. In a first step 1401, a set L of tags made by participating users (using method 1300) for a particular campaign is loaded as input to method 1400. Typically, each tag will comprise a tag identifier, a tagger identifier (each participating user is given a unique identifier, and all tags made by a specific participating user will have the same tagger identifier), a location (either latitude and longitude, or UTM grid plus easting and northing values, or another geospatial reference location), and a type of tag (for example, “tank”, “debris field”, “building”, and the like). Of course, other data elements may be provided as well, such as overlay identifiers (when multi-layer maps and tagging are used), but the core elements of tag identifier, tagger identifier, tag type, and tag location will generally always be present. In step 1402, each tag in L in turn has agreement and disagreement values computed. This is done by taking a specific tag and then looping over all other tags in L. The specific tag may be given an agreement value of 1 (because it by definition agrees with itself; of course, values other than 1 may be used for agreement, according to the invention). For each other tag that is considered with respect to the specific tag, a distance computation is made from the specific tag to the other tag. In a preferred embodiment, if the computed distance is less than a first specified (configurable) value (i.e., the other tag is “close” to the specific tag), then a new entry is added to L for the other tag, and an agreement value of 1 is assigned; if the distance is more than the first specified value but less than a second specified (also configurable) value (the second specific value always being greater than the first specific value), then the other tag is “sort of close” to the specific tag, and a new entry is added to L for the other tag, with an agreement value of 0 (disagreement; as in the case of agreement, a value other than 0 can be used in some embodiments); finally, if the computed distance is greater than the second specific value, then the other tag is considered unrelated to the specific tag, and no new element is added to L. It should be clear that, upon completion of step 1402, a vector of tags L that initially had length Len(L) will now be much larger, having a length given by X*Len(L), where X is the average number of new entries added per tag (that is, the average number of tags that are either close or sort of close to a given tag); furthermore, each element in L will, after step 1402, have an agreement/disagreement value.

It should be noted that the method just described is one way of assigning “agreement” and “disagreement” values; others are possible according to the invention as well. For example, consider that the radius may represent a circular “kernel” with the tag of interest at its center. If another tag were inside the kernel, it could be considered to agree with the tag of interest. One can then extend the idea of a kernel to include any arbitrary shapes (and one can assign agreement values that are between zero and one, for example depending on distance from the center). As an example of such an approach, when detecting roads or other straight-line type of features, the kernel could be a long skinny ellipse. The ellipse could be rotated through all possible angles; the angle for which the highest number of other nearby tags “agree” would be the one that is chosen and then used to establish agreement and disagreement values (which again may be binary or continuously-valued). Of course, other shapes could also be rotated; for example, an “X” shape could be used to detect road intersections. Similarly, disagreement also can be assigned in many possible ways. The way described above corresponds to a disagreeing tag's falling inside of one kernel while falling outside of another. Or, a tagger who views an area of another user's tag but does not “agree” automatically disagrees. In this case, it is not a tag “disagreeing” with another tag, but rather it is another user disagreeing with a tag of interest. In some embodiments, it is desirable to send users to a specific, discrete set of locations, in order that it may be definitely established that two or more users saw exactly the same thing, in which case disagreement can be more readily ascertained (and with a higher degree of confidence).

Once L has been expanded as described in step 1402, in step 1403 initial values are assigned for arrays A, B, and Z. A is an array comprising one element for each unique tagger (participating user) who has provided at least one tag to L. Each element of A may comprise a tagger identifier (the unique identifier for a specific participating user), a mean quality of tags made by the specific tagger, and a standard deviation of the quality of tags made by the specific tagger. “Quality” means, in a preferred embodiment, a value from −1 to 1, where −1 means the specific tag by a specific tagger is completely malicious (known to be false), 1 means the specific tag by the specific tagger is completely trustworthy (known to be true), a value less than 0 but not equal to −1 means the tag is more likely than not to be malicious, and a value greater than 0 but less than 1 means the tag is more likely than not to be reasonable (i.e., not malicious). A value of 0 indicates that a tag is inaccurate but not malicious. Initial values of the elements in A may be either loaded from database 1232 as priors, or may be instantiated (for each tagger identifier) with default values (such as 0 mean, 0 standard deviation). Similarly, quality values may be assigned based on disagreement; for instance, a user may see a really obvious object to tag and not tag it, either because he is inept or malicious. Each element of B may comprise a tag identifier (the unique identifier for a specific tag), a mean difficulty of the tag as made by various taggers (that is, if many taggers identified a “tank” at a location, the difficulty scores for each such tag are averaged), and a standard deviation of the difficulty of the tag as made by various taggers. “Difficulty” means, in a preferred embodiment, a value from 0 to 1, where 0 means the specific tag is “very easy” (very likely to be correctly tagged by a random tagger), and 1 means the specific tag is “very hard” (very unlikely to be correctly tagged by a random tagger). Initial values of the elements in B may be either loaded from database 1232 as priors, or may be instantiated (for each tag identifier) with default values (such as 0.5 mean, 0 standard deviation). Each element of Z may comprise a tag identifier (the unique identifier for a specific tag), and a probability value, which represents the probability that the specific tag is correct (meaning it correctly tags a real object). Initial values of the elements in Z may be either loaded from database 1232 as priors, or may be instantiated (for each tag identifier) with default values for the probabilities for each tag (such as 0.5). Recall that L is a set of input obtained from users attempting to tag objects in images; it is assumed that there is a hidden variable representing the set of all actual targets of interest in the region covered by the images, so the probabilities in Z represent the likelihood that a given tag represents an actual object in the specific geospatial location associated with the tag in question. The goal of method 1400 is to obtain maximized (at least locally) values of Z, given parameter sets A and B. Accordingly, in step 1404 (the expectation step), an expectation of the maximum likelihood P that Z reflects the underlying hidden variable (the actual targets of interest in the image field), given the parameter vectors A and B, is computed in the normal way using the current values of A and B. Then, in step 1405, vectors A and B are merged into a single vector AB (note that each element of A and of B has form {ID, Mean, StdDev}, so merging the two vectors—by concatenation—creates a single vector comprising elements of the same form), in preparation for carrying out the maximization step. Then, in step 1406, the maximization step is carried out by estimating a new value ABₙ₊₁ based on ABₙ by iteratively computing the argument of the maximum of Q(Z|ABₙ) over all Z, where Q is computed in the normal way. Once this is done, the vector AB is unpacked into its components A and B in step 1407, and in step 1408 a test is made to determine whether either a configured maximum number of EM iterations has occurred (requiring termination to avoid possible endless loops and to limit the time of operation of the CrowdRank algorithm) or whether the change in AB is less than a configured minimum (meaning convergence has occurred); if either of these conditions is met, then method 1400 moves to step 1410 and the final values of A, B, and Z are output by CrowdRank service 1240 to the user or application that originally requested the CrowdRank algorithm to be executed. If neither of the conditions of step 1408 is met, then in step 1409 the new values of A and B (taken from the unpacked ABₙ₊₁) and Z (determined as part of the maximization step) are returned and execution resumes again at step 1404, for another iteration of the EM algorithm.

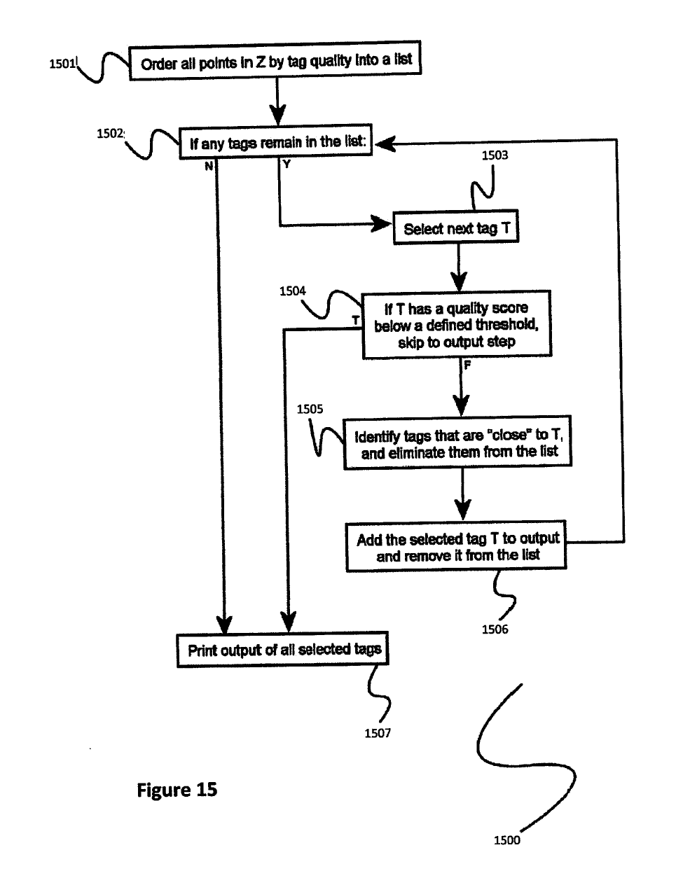

FIG. 15 is a process flow diagram of a method 1500 to accurately geolocate a plurality of targets using a crowdsourced image analysis platform of the invention. Once the method 1400 has been carried out, an array of tags and their probabilities (that is, Z) is available, but it is still unclear what a set of real or actual targets of interest in the region covered by the images from which the tags were made is. For example, many of the tags in Z may be duplicates of other tags (for instance, if several different taggers tag the same object), and the precise location of each real object is yet to be determined. It should be evident that such locations are likely to be closest to the corresponding tag that has the highest probability value (recall that Z comprises tuples of {tag ID, probability}). Accordingly, a clustering method 1500 is provided in various embodiments of the invention. Upon commencing method 1500, in step 1501 all of the points in Z are ordered (sorted) by tag quality (that is, by the probability of each tag's being correct). Then, in step 1502 a check is made to see if any tags remain in the list; if none do, execution passes to step 1507 and the output of all selected tags is printed or returned to a requesting entity. Otherwise, in step 1503 the next tag T (by definition, the highest remaining tag in order of probability/quality) is selected. In step 1504, the quality score or probability of tag T is checked to see if it is below a defined (configurable) threshold. If it is below the threshold, then execution jumps to step 1507 and the output of all selected tags is printed or returned to a requesting entity. If the quality score of tag T in step 1504 is above the threshold, then execution continues to step 1505. In effect, step 1504 and the threshold it uses together mean that all tags whose quality is below the configured threshold are discarded and never placed into the output buffer that is passed to step 1507. In step 1505, all tags (necessarily below T in the list Z) that are close to T (that is, whose geospatial distance from T is less than a configured distance, which may or may not be the same as the first specific distance used in method 1400; or all tags that are inside a specific agreement kernel) are discarded from the list, and in step 1506 tag T is added to an output buffer (which starts as an empty buffer before step 1501), and tag T is removed from list Z (note that in most embodiments a “working copy” of Z would be used in method 1500, so the full original Z is maintained for use elsewhere). Once T has been added to the output buffer and removed from Z (or “the working copy of Z”), execution returns to step 1502. Thus it will be apparent to one having ordinary skill in the art that the clustering approach of method 1500 starts with Z (and gets location data from L using the tag identifier in each element of Z), and works down the list in order of probability (quality), taking each tag T, removing its nearby neighbors from the list, adding T to the output, and removing T from the list until either the list is emptied or the next tag T has a quality that falls below a defined threshold. Thus for each tag T′ in the output when execution passes to step 1507, there is a strong likelihood that the object specified by tag T′ actually exists, and that the output contains no duplicates. It will be apparent that the setting of the “closeness parameter” used in step 1505 is an important parameter, since in general if two real objects exist in the region covered by the image set used, and their real distance is less than the “closeness parameter,” method 1500 will likely report only one target in step 1507. This would argue for a low value of the closeness parameter; however, a very low value of the closeness parameter would result in many duplicate objects in the output of step 1507 if it is set to a value lower than or close to the average error in tag location made by users. Fortunately, since the computational cost of methods 1400 and 1500 is quite low for reasonably sized datasets, it is quite practical for a requesting entity to run the CrowdRank algorithm (the methods 1400 and 1500) multiple times, with different parameter settings, during a single analysis session, to determine an optimal setting for a given campaign (optimality will depend on the type and size of targets sought, image resolution, participating user experience, and so forth).

Crowdsourcing has been done in many ways. However, in the case of crowdsourcing to obtain data for editing and correcting map data, many improvements can be made to the process, thus improving the reliability and predictability of maps. For example, ranking the quality of the output of each crowdsourcing participant enables the map makers to understand the particular skills and abilities of each participant in various areas, such as, for example, skills and knowledge for urban areas, for mountain areas, for large infrastructure areas, etc. Additionally, some machine interpretations of the initial image data may be used to create the framework as a starting point. Additionally, map data from other sources may be combined, and the combination presented to participants. In some cases, participants may get map data to work on where already a good map exists to accurately identify how the quality of said participant's output may compare to the quality of a normalized aggregate crowdsourcing community output. Of course, the assignment of image chips and map data to participants may be randomized to reduce the opportunity to introduce fraudulent or other malice-motivated data into the system. In other cases, it may desirable to use some other a prior knowledge to assign people to non-random locations. Also, each image chip is typically sent to a number of participants, which number may vary from as few as three or five up to more than 100, depending on the importance and the size and scope of the project.

Comparing the performance of map data annotations by various participants on known areas that already have accurate map data and also noting differences in performance on different types of terrains enables highly accurate ranking of the capabilities of each participant, so that the system can determine which participants are best employed on which type of terrain, not just in global terms across all terrains, but in relative terms for different types of imagery. Further, the preprocessing of the raw imagery enables the system to determine which participants should get which image chips to get the best results in the quickest way.

Other sources of map data may be, for example, existing map systems, open source map systems, commercial or government maps, etc.

The resulting improved maps may be used by government agencies as well as non-government organizations (NGOs), and commercial organizations to provide valuable services to areas that don't currently have sufficiently accurate maps and/or infrastructure.

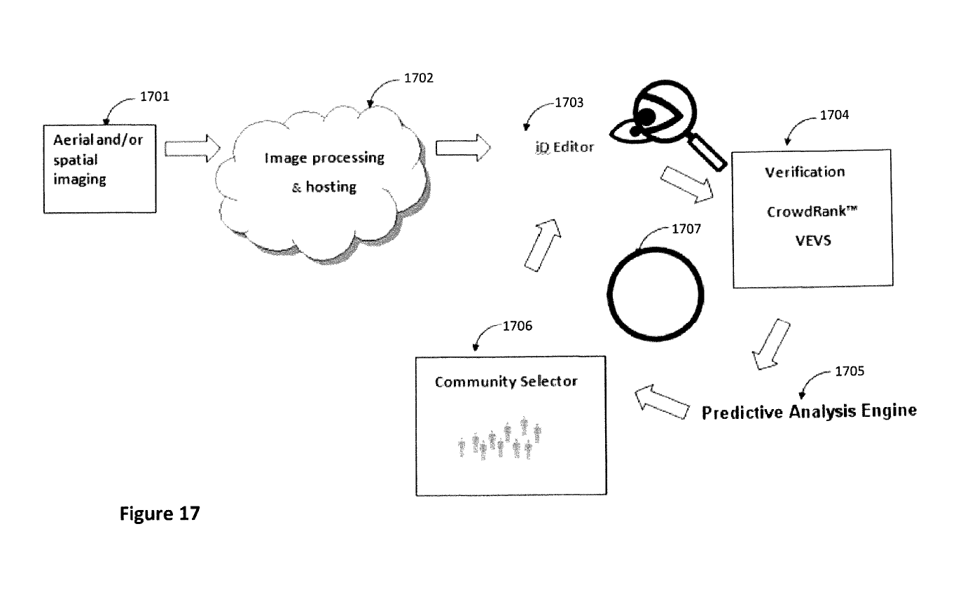

FIG. 17 shows a high-level data flow 1700 of the system, in which scalable hosting and processing are followed by a tight quality control loop to keep the crowd engaged, producing accurate information and verifying road data. In step 1701 data is acquired during flyovers of vehicles such as, for example, airplanes, satellites, drones, UAVs, etc. In step 1702 the acquired data is processed and hosted in a cloud system, which system is described herein earlier and throughout. In step 1703 particular images are selected to for editing, for example using a map editor (although other user interface elements may be used to select images for editing, according to the invention). In step 1704 the selected data is verified, using CrowdRank™ VEVS. In step 1705 a predictive analysis engine 1901 is used to verify that the previous steps have been done correctly, and based on the analysis, a community is ranked and selected. Predictive analysis engine 1901 is a program that can recognize that a map is coherent. In step 1706 a community selection process is conducted, which may for example assign particular members of a community to specific crowdsourcing work (i.e., by assigning them specific images for reviewing, or assigning them to a particular high-priority campaign, etc.). Assignments may be made based on various factors in step 1706, including for example (but not limited to) use of a graphical community selection tool by a human campaign administrator; random assignment of community users; assignment of users based on predictive analytics; optimized assignment of users based on analysis of past performance; and so forth. The process of steps 1703 through 1706 may require several rounds 1707 before predictive analysis engine 1901 is satisfied with the results and that the data makes sense.

FIG. 18 shows a verification process 1800 using the CrowdRank™ VEVS. Open Street Map (OSM) vectors 1801 and image chips 1802 from which the OSM vectors were derived are overlaid on each other. The data is then sent to crowdsourcing participants for the verification process. Regions are prioritized based on their importance, such as, for example, their impact on the humanitarian community. They are also ranked for data reliability. The participants can then edit and correct the map to help improve the image, using a crowdsourced image and map data system (CIMDS) 1806. VectorUpdate™ within the crowdsourcing system is part of RoadTracker, which is a software system to create vectors by following linear shapes in images, assuming they are roads (or, secondarily, other linear types of infrastructure, including, but not limited to, railroads, pipelines, walls, etc. The vector reliability score 1803 is calculated by comparing crowdsourced vectors against the calculated vectors and by incorporating additional information such as crowd agreement, crowd metadata information, and other information about the vector modifications. Vector updates may then be inserted to help fill in recognizable objects and areas, such as roads, geographical features, etc. Crowdsourcing may provide an effective means of validating or correcting automated vector updates. The user reliability score 1804 is calculated by calculating the deviation of a given user from the crowd, to identify the likelihood that certain users may contribute wrong information. Suspect information is compared to the crowd's determination and then either accepted or rejected, with some notation of it referring to where it should be inserted, noting that if a normally very reliable user has difficulty, the terrain should probably be considered difficult. Generating a reliability score adds statistical rigor to the peer review process. The likelihood of these reliability scores is based on machine learning. Then the data is assessed for difficulty 1805 in digitizing that particular region, which is one of a set of chips in an area, based on the degree of accuracy and the spread of the reliability scores, both for users and for vectors. When the reliability scores are acceptably high, predictive analysis engine 1901 is used to increase the predictive analytics capability of the system and method disclosed herein, as described below.

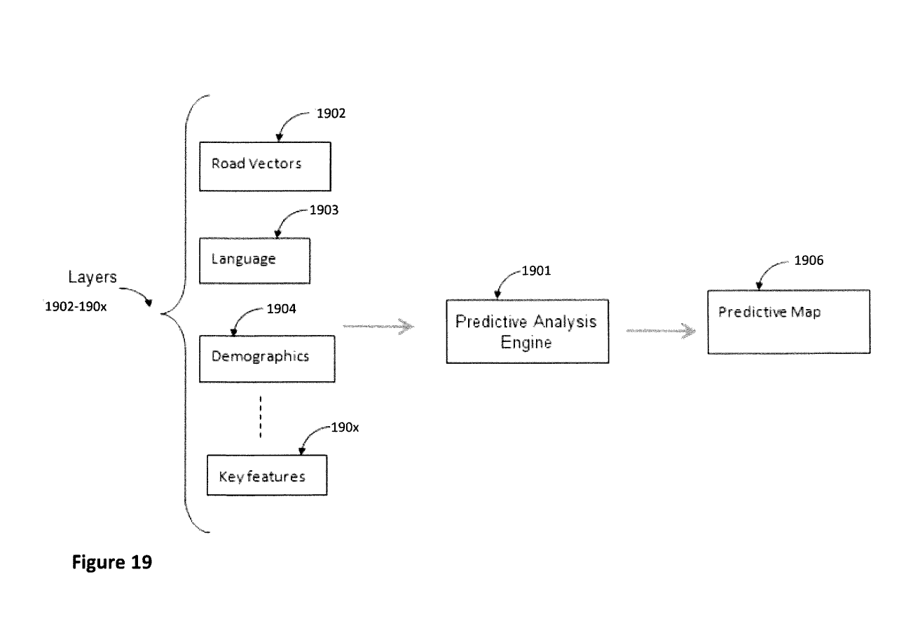

FIG. 19 shows how predictive analysis engine 1901 (which is the same predictive analysis engine described earlier in the discussion of step 1705 in FIG. 17) has all the data together. Various vector fields and other demographic data from various sources are combined into layers, shown, in this example, as layers 1902 through 190x. More layers are possible, as indicated by the dashed line between 1904 and 190x. Predictive analysis engine 1901 combines the layers, based on the reliability scores, and produces predictive map 1806 that contains all the gathered and validated data. This map may be used for all kinds of further analyses, both in-house and in the field. A high level analyst has the capabilities required to bring domain and local knowledge together for effective prioritization.

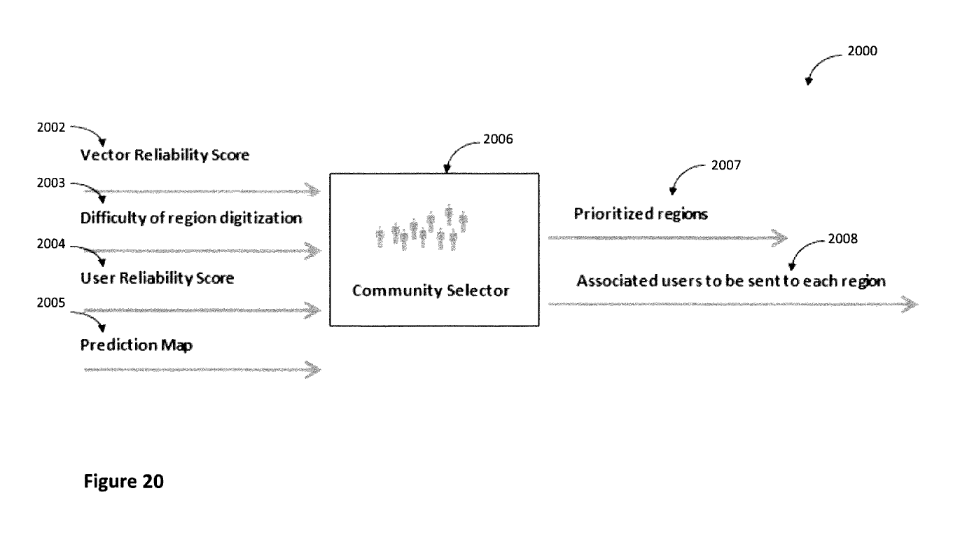

FIG. 20 shows the process 2000 of the continuing data editing and corrections. As described above and throughout, vector reliability score 2002, the degree of difficulty of region digitization 2003, user reliability scores 2004, and prediction map 2005 from the system analyst are all taken into account in a crowdsourcing targets and member selection system (CTMS) such as, for example, Community Selector, which selects prioritized regions 2007 and associated users 2008 (crowd members), based on their reliability score, to continue to refine and correct data.

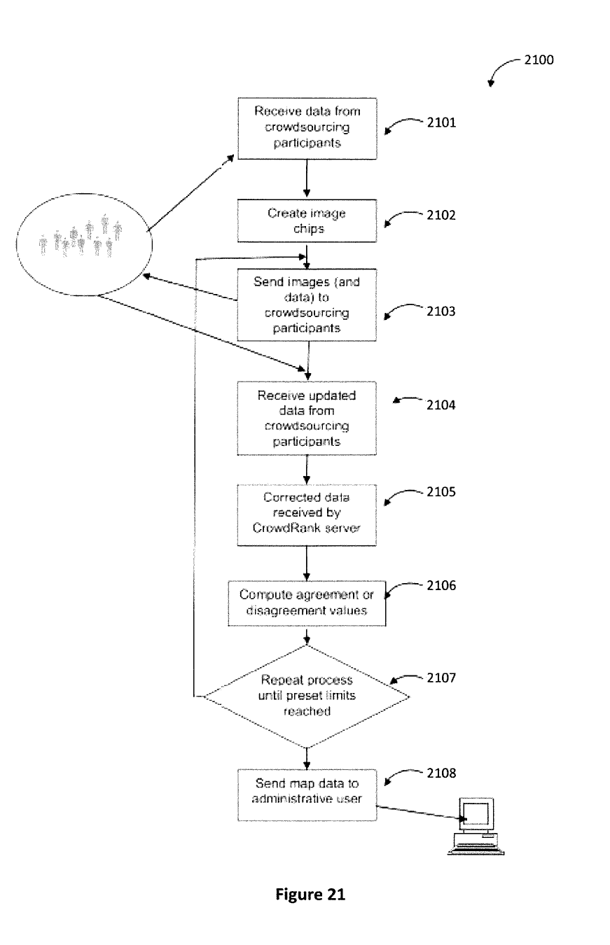

FIG. 21 shows a linear process flow of crowdsourced map data cleanup and correction system 2100. In step 2101, an application server receives data from crowdsourcing participants. In step 2102, the application server uses said data to create image chips for segments of map data to be created or cleaned up. In step 2103 the server sends an image with any available corresponding data to crowd-sourcing participants, and in step 2104 it receives tagging and/or correction data from crowdsourcing participants. In step 2105 the CrowdRank server retrieves tags and/or corrections made by crowdsourcing participants by repeated iterations of steps 2101 through 2104. In step 2106 the CrowdRank server computes agreement and disagreement values for each retrieved tag. The server then in step 2107 performs an expectation-maximization or expectation-minimization process iteratively until a configured maximum number of iterations is performed or until an indicia of rate of change between iterations falls below a configured threshold. In step 2108 the server then outputs map data to an administrative user. In some cases, the image chips may contain 3-D viewable images of an area, aiding crowd-sourcing participants to better recognize difficult objects.

The skilled person will be aware of a range of possible modifications of the various embodiments described above. Accordingly, the present invention is defined by the claims and their equivalents. Various embodiments of the present disclosure may be implemented in computer hardware, firmware, software, and/or combinations thereof. Methods of the present disclosure can be implemented via a computer program instructions stored on one or more non-transitory computer-readable storage devices for execution by a processor. Likewise, various processes (or portions thereof) of the present disclosure can be performed by a processor executing computer program instructions. Embodiments of the present disclosure may be implemented via one or more computer programs that are executable on a computer system including at least one processor coupled to receive data and instructions from, and to transmit data and instructions to, a data storage system, at least one input device, and at least one output device. Each computer program can be implemented in any suitable manner, including via a high-level procedural or object-oriented programming language and/or via assembly or machine language. Systems of the present disclosure may include, by way of example, both general and special purpose microprocessors which may retrieve instructions and data to and from various types of volatile and/or non-volatile memory. Computer systems operating in conjunction with the embodiments of the present disclosure may include one or more mass storage devices for storing data files, which may include: magnetic disks, such as internal hard disks and removable disks; magneto-optical disks; and optical disks. Storage devices suitable for tangibly embodying computer program instructions and data (also called the “non-transitory computer-readable storage media”) include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Further, the terms screen, window, display etc. are being used to some degree interchangeable, as a screen (a set of data) may be presented within a window on a physical screen or display, as well as data may be displayed in a window, on a screen.

In some cases, large-scale crowd-sourcing of map data cleanup and correction may be done with an application server coupled to a digital packet network; with a crowd-rank server stored and operating on a network-attached computer and coupled to the application server, and with a map data server stored and operating on a network-attached computer and coupled to the application server. In such cases, the application server may receive connections from crowd-sourcing participants, may create so-called “image chips” for segments of map data to be created or cleaned up, may send an image with any available corresponding data to crowd-sourcing participants, and may receive tagging and/or correction data from crowd-sourcing participants. In addition, the crowd-rank server may retrieve tags and/or corrections made by participating users; it may compute agreement and disagreement values for each retrieved tag; it may perform an expectation-maximization or expectation-minimization process iteratively until a configured maximum number of iterations is performed or until an indicia of rate of change between iterations falls below a configured threshold; and it may output values corresponding to geolocations of map data to an administrative user. In some cases, the image chips may contain 3-D viewable images of an area, aiding crowd-sourcing participants to better recognize difficult objects.

### Description of Anthropological Mapping System Embodiments

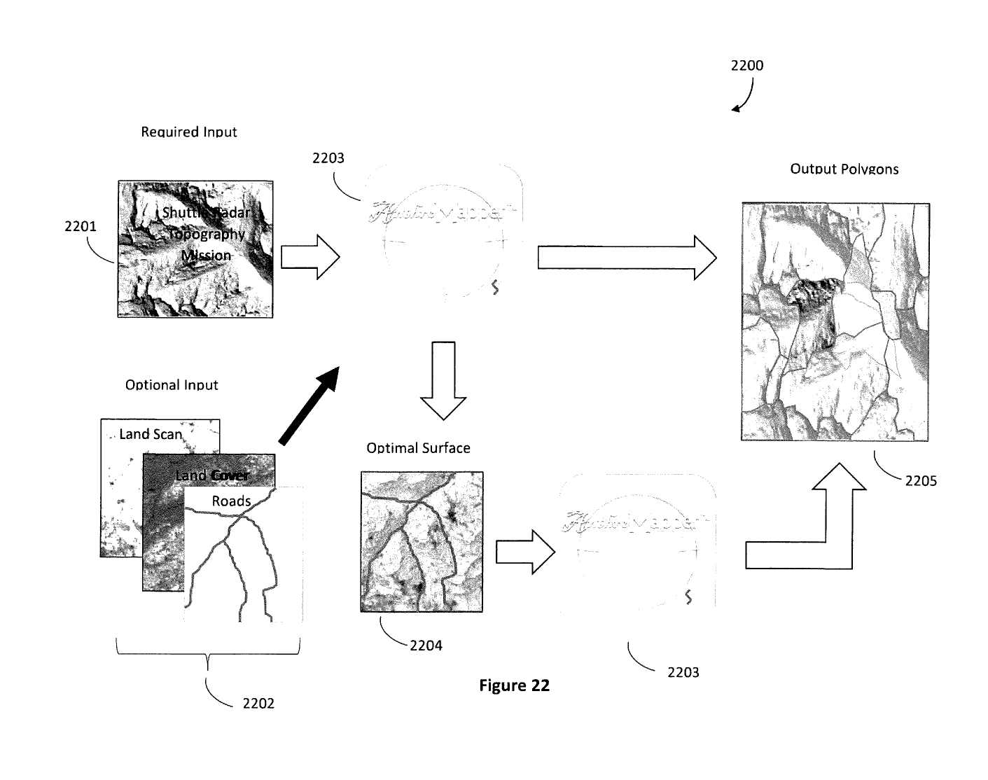

FIG. 22 shows an exemplary workflow summary 2200 for assembling the data for an AMS mapping as presented in this system. Data 2201 from a shuttle radar topography mission (SRTM) is required input to create certain features, such as elevation data, population data and known tribal locations. From that data, and from additional optional inputs 2202a-n such as, for example, land scan, land cover, and roads that are overlaid on it, the mapping system 2203 creates an optimal surface map 2204 that contains all the constituent maps. Mapping system 2203 also creates a set 2205 of geography information system (GIS) polygons to represent areas of human congregation and influence which are dictated by terrain, access to water resources, and lines of communication. This set shows separate areas by geographic features, such as, for example, mountain ridges, bodies of water, ice flows, etc. It happens that usually local tribal affiliations are within those separations, and the output polygons follow these features.

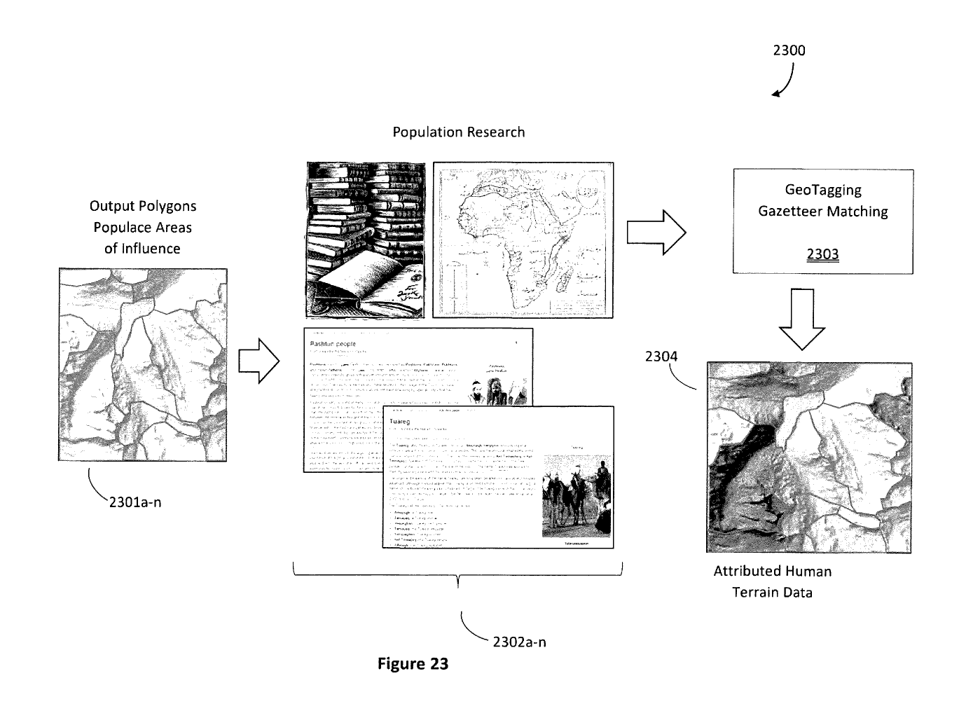

FIG. 23 shows a continued workflow summary 2300. The areas of output polygon set 2301 are used for population research, which is typically done manually, but may also be done with a combination of automated search and manual search. Data from population research from various sources 2302a-n is compiled to fill in each multiple of the polygons in output polygon set 2304, which describe populace areas. This approach enables the system to characterize each of the various different areas and then, depending on whether they have the same or different attributes, they are colored in accordingly.

Thus the output of FIG. 22, namely polygon set 2205, is used as the input 2301 in FIG. 23. The polygons are filled in, and using the different search processes on sources 2302a-n, such as automatic spidering by geo-located information and research in various sources, such local publications, wiki pages, etc., the result is a set of human-attributed terrain data. This data set can now be used, for example, when planning a mission through those areas, to understand which local populaces are active in a certain area. Thus the mission planners have reliable information about, for example, when going from point A to point B, how many different tribal areas must be traversed. And, accordingly, they now can knowledgeably arrange for permissions, cooperation, etc.

The mapping system disclosed herein in some cases has two components: a light-weight GUI that integrates with existing third-party viewer editors for geo-spatial data, including but not limited to ArcMap/ArcGIS or other similar products, and a back end server that is responsible for most of the computation. The mapping system utilizes raster processing elements in friction surface calculations for best results. It supports some research on optimal input surface layers (built for social mapping), fluid model changes if more input layers are available, and functionality with a limited number of input geo-spatial layers.

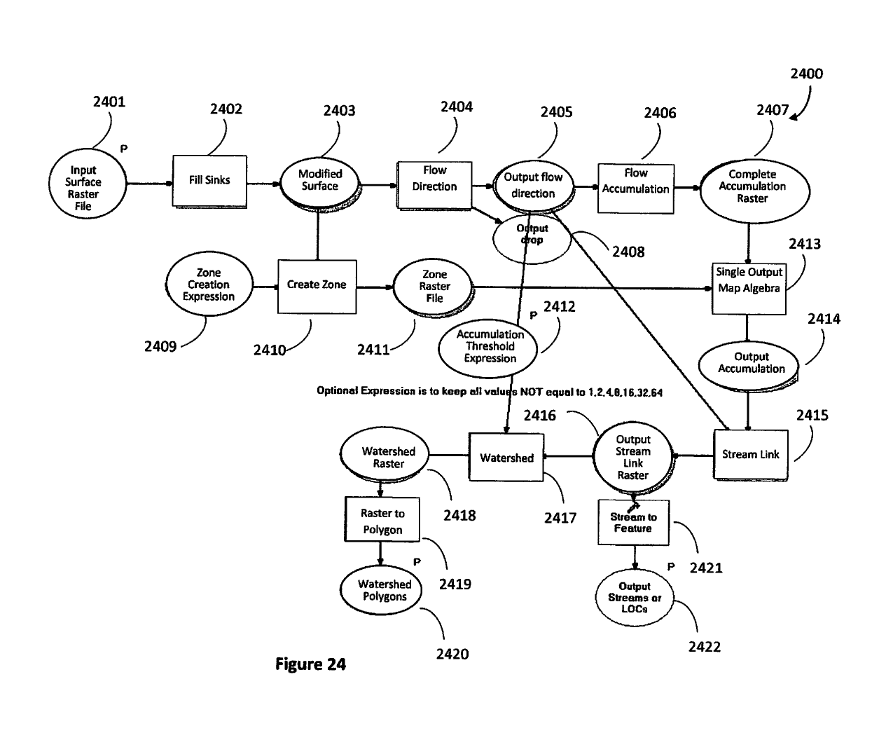

FIG. 24 shows an exemplary hydrological workflow 2400, according to one aspect of the system and method disclosed herein, for developing the watershed model for the polygons used in FIGS. 22 and 23 above. The input components are primarily the input surface raster file 2401, which is a kind of radar map showing the area, and also the elevation of each location based on the raster size, the zone creation expression 2409, and in some cases an accumulation threshold expression 2412. In step 2402 the surface raster file is processed by filling in the lowest points of each area, thus creating a modified surface 2403, which is used to create a zone 2410 and also to determine flow direction 2404. In step 2404 additionally information is created and mapped about the output drop 2408, which is the output of a sink area where all the water flows from a certain watershed. Output flow direction 2405 is then determined, and this data is fed into watershed module 2417 and into stream link module 2415, which is used to stitch together a larger object or map layer with some neighboring areas whose raster data is incomplete because rasters are available in limited-size segments, typically squares. The output flow direction 2405 is used to calculate flow accumulation 2406. In step 2407 the accumulation raster is completed. It is then combined with zone raster file 2411, which was created from create zone 2410, into a single output map algebra 2413, describing the watershed and its boundaries. The output is accumulated and combined with output flow direction into a stream link, so contiguous streams are obtained. That data is then rastered again in step 2406 to create an output stream link raster. From that raster, stream-to-feature-derivation model 2421 creates output stream or locations 2422. Also output stream link raster 2416 is combined with output flow direction 2405 to determine the actual watershed model 2417. Then a watershed raster is created in step 2418. In step 2419 the raster is vectorized to polygon form, so each watershed is described by a sequence of vectors, or sides, describing a polygon that contains the whole watershed. Then the whole map is converted into watershed polygons 2420, which can be used as described above in the discussions of FIGS. 22 and 23. All the information created and collated in FIGS. 22 thru 24 are typically stored in layers that connect to a mapping system of the AOI.

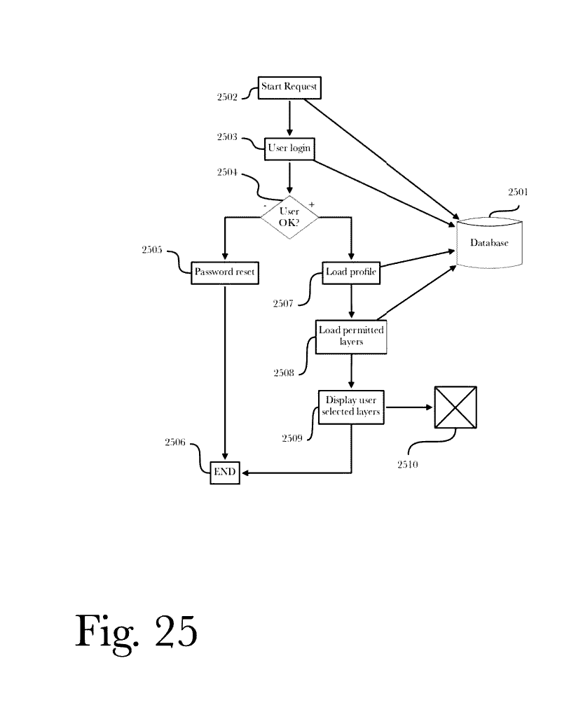

FIG. 25 shows an exemplary process 2500 for viewing the data previously assembled, according to one aspect of the system and method disclosed herein. Data repository 2501 is shown here as a single unit, for reasons of clarity and simplicity; however, in reality, data may be sent to and obtained from any and all of several types of data storage. In step 2502 the system receives a start request. In step 2503 the user logs in, and in step 2405 the system verifies the user's identity. If the login is not successful (−), the system may in step 2505 offer a password reset or some other, similar type of credential reset, and the process then ends at step 2506. If, in step 2504, the user verification is successful (+), in step 2507 the user's profile is load. This profile may contain user preferences, plus additional information such as user rights and user history. User rights pertain to the user's ability to access various layers of information, as discussed earlier. Information layers may be available as separate layers or as combined layers, depending on certain user rights, such as commercial, safety, security, etc. Based on the user's rights, the system loads the permitted layers in step 2508 and, in step 2509, the layers are displayed on an appropriate device, typically some kind of computer or mobile communication device. The information may be viewed via a proprietary viewing program or via a standard web browsing and information viewing program appropriate to the user's device. Depending on information sensitivity and user rights, the system may permit the user to send messages about the data via link 2510. The system could enable transmission of such items as links to information sources, or alerts to other users to view certain data of interest, or user comments about certain content, or any other similar, suitable types of messages permitted to the user, according to his specific rights in the system. When the user is finished viewing data, the process ends at step 2506.

Integration of several unique satellite and other geo-spatial information sources enables extension of the functionality and value of the system and method disclosed herein. Specifically, integrating an automatically generated HUG data set generated in near-real-time from satellite imagery expands its utility significantly. In some cases geographical and economic data extracted from satellite images may be enriched with data pulled from additional sources. Using automated HUG data, a user can obtain geo-spatially tied data on building locations and sizes. All data may be aggregated as layers into a geo-spatial temporal map for predicting future urban growth.

Incorporation of accurate digital elevation models (generated automatically from satellite imagery) and use of friction surfaces enables exemplary prediction of future urban growth, particularly when coupled to an up-to-date dataset of roads (including unofficial roads and paths). Road data sets, including official roads, unofficial roads, paths and other ground tracks may be used to improve the accuracy of predictions. With automated road network generation, users get the road network even in areas where accurate maps aren't available. Even retail traffic can be determined automatically, using parking lot detection and usage measurement. Further, automated counting, from satellite imagery, of things like rail car inventories, oil tank farm inventories, and the like provides additional geo-spatially referenced economic data. In some cases, output polygons may be used to delineate limitations of growth due to geography. Language identification applied to geo-tagged posts (tweets, Facebook, etc.) enables inference of language distribution. In other cases, it may be used to plan multi-lingual, multi-cultural media campaigns.

The AMS disclosed herein ingests all these data sources and automatically analyzes them to produce human geography data sets and predictions about the future (for example, which tribes are dominant in which areas; what languages are spoken where; where is radicalization most likely to occur; where are future likely high-crime areas based on predicted population and infrastructure growth). And, given the near-real-time aspect that can achieved, mobile use cases such as providing assets in the field with real-time heads up about emerging threats determined from human geography (for example, recent trends indicating development of a hostile crowd in vicinity of a mobile asset, with threat delivered to mobile device in real time).

Various embodiments of the present disclosure may be implemented in computer hardware, firmware, software, and/or combinations thereof. Methods of the present disclosure can be implemented via a computer program instructions stored on one or more non-transitory computer-readable storage devices for execution by a processor. Likewise, various processes (or portions thereof) of the present disclosure can be performed by a processor executing computer program instructions. Embodiments of the present disclosure may be implemented via one or more computer programs that are executable on a computer system including at least one processor coupled to receive data and instructions from, and to transmit data and instructions to, a data storage system, at least one input device, and at least one output device. Each computer program can be implemented in any suitable manner, including via a high-level procedural or object-oriented programming language and/or via assembly or machine language. Systems of the present disclosure may include, by way of example, both general and special purpose microprocessors which may retrieve instructions and data to and from various types of volatile and/or non-volatile memory. Computer systems operating in conjunction with the embodiments of the present disclosure may include one or more mass storage devices for storing data files, which may include: magnetic disks, such as internal hard disks and removable disks; magneto-optical disks; and optical disks. Storage devices suitable for tangibly embodying computer program instructions and data (also called the “non-transitory computer-readable storage media”) include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

The above-described embodiments including the preferred embodiment and the best mode of the invention known to the inventor at the time of filing are given by illustrative examples only.

Changes and modifications may be made to the disclosed embodiments without departing from the scope of the present disclosure. These and other changes or modifications are intended to be included within the scope of the present disclosure, as expressed in the following claims.

What is claimed is:

1. A system for combining geographical and economic data extracted from satellite imagery, comprising:
an application server comprising at least a plurality of programming instructions stored in a memory and operating on a processor of a network-connected computing device and configured to receive input from a plurality of users via a network, at least one of the users comprising an administrative user, the input from an administrative user comprising at least a plurality of campaign configuration information, and configured to operate a crowdsourced campaign based at least in part on at least a portion of the campaign configuration information, the crowdsourced campaign comprising at least a plurality of image analysis tasks, and further configured to provide at least a portion of a plurality of image analysis tasks associated with a campaign to at least a portion of a plurality of users, and further configured to provide at least a portion of a plurality of image data to at least a portion of a plurality of users; and
a crowdrank server comprising at least a plurality of programming instructions stored in a memory and operating on a processor of a computing device, and configured to receive a plurality of input from a plurality of users, the input comprising at least a plurality of information tags associated with at least a portion of a plurality of image data, and further configured to analyze at least a portion of the information tags and organize the portion of tags based at least in part on the analysis results.

2. The system of claim 1, wherein at least one of the portion of tags is determined to be the tag most likely to be accurate, the determination being based at least in part on the analysis results.

3. The system of claim 1, wherein the plurality of image data comprises at least a plurality of satellite image data, the satellite image data comprising a plurality of geographical information counts determined by a satellite during image capture.

4. The system of claim 3, wherein the plurality of geographical information counts comprises at least a count of visible transportation features.

5. The system of claim 4, wherein the visible transportation features comprise at least a plurality of parking lots.

6. The system of claim 3, wherein the plurality of geographical information counts comprise at least a count of visible inventory features.

7. The system of claim 6, wherein the visible inventory features comprise at least a plurality of oil storage tanks.

8. A method for ranking a plurality of crowdsourced image analysis information, comprising the steps of:
sending, via an application server comprising at least a plurality of programming instructions stored in a memory and operating on a processor of a network-connected computing device and configured to receive input from a plurality of users via a network, at least one of the users comprising an administrative user, the input from an administrative user comprising at least a plurality of campaign configuration information, and configured to operate a crowdsourced campaign based at least in part on at least a portion of the campaign configuration information, the crowdsourced campaign comprising at least a plurality of image analysis tasks, and further configured to provide at least a portion of a plurality of image analysis tasks associated with a campaign to at least a portion of a plurality of users, and further configured to provide at least a portion of a plurality of image data to at least a portion of a plurality of users, a plurality of image information to a plurality of users;
receiving, at a crowdrank server comprising at least a plurality of programming instructions stored in a memory and operating on a processor of a computing device, and configured to receive a plurality of input from a plurality of users, the input comprising at least a plurality of information tags associated with at least a portion of a plurality of image data, and further configured to analyze at least a portion of the information tags and organize the portion of tags based at least in part on the analysis results, a plurality of user input comprising at least a plurality of information tags associated with at least a portion of a plurality of image information;
analyzing at least a portion of the information tags to determine at least an agreement value corresponding to at least a number of users that provided a similar information tag; and
storing at least a portion of the information tags for future reference.

9. The method of claim 8, further comprising the steps of sending a plurality of information tags to a plurality of users via a network, and receiving feedback information from at least a portion of the users, the feedback information comprising at least an agreement value based on a user's level of agreement with a particular information tag.
